(19) United States
(12) Patent Application Publication
(10) Pub. No.: US 2002/0013664 A1
(43) Pub. Date: Jan. 31, 2002

(54) Rotating equipment diagnostic system and adaptive controller

(76) Inventors: Jens Strackeljan, Clausthal-Zellerfeld (DE); Andreas Schubert, Hammah (DE); Dietrich Behr, Clausthal-Zellerfeld (DE); Werner Wendt, Drochtersen (DE)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/867,085

(22) Filed: May 29, 2001

Related U.S. Application Data
(60) Provisional application No. 60/212,392, filed on Jun. 19, 2000.

(51) Int. Cl. G01B 3/44; G01B 3/52; G06F 19/00

(52) U.S. Cl. 702/34

(57) ABSTRACT

A system and method for control and monitoring of rotating equipment through the use of machine status classification where, in one embodiment, adaptive control measures responsive to the machine status are implemented. The invention provides a computer-implemented method for monitoring a mechanical component using either a neural network or weighted distance classifier. The method references a predetermined set of candidate data features for a sensor measuring an operational attribute of the component and derives a subset of those features which are then used in real-time to determine class affiliation parameter values. The classification database is updated when an anomalous measurement is encountered, even as monitoring of the mechanical component continues in real-time. The invention also provides a dimensionless peak amplitude data feature and a dimensionless peak separation data feature for use in classifying. An organized datalogical toolbox for operational component status classification is also described.

### CROSS REFERENCE

This application claims the benefit of U.S. Provisional Application No. 60/212,392 filed Jun. 19, 2000.

### FIELD OF THE INVENTION

The present invention relates to process control and process monitoring, particularly to control and monitoring of rotating equipment through the use of machine status classification where, in one embodiment, adaptive control measures responsive to the machine status are implemented.

### BACKGROUND

As automation of production facilities and manufacturing processes has progressed, the number of human operators working with consistent attention to machines used in those facilities and processes has decreased; in compensating for this diminishing intimate involvement of operating technicians with the machines, quality control and quality assurance monitoring with computers programmed to mirror human logical and intuitive understanding has gained importance. Automatic diagnostic systems utilize pattern recognition, embedded rules, and functional relationships to characterize measurements of the monitored machine in operation; and a human expert frequently is involved in helping to interpret the measurements. Expert rule sets, classifiers, neural network-based analysis, and fuzzy-logic systems are gradually extending the productivity of human experts in providing automated systems which can generate routine feedback and status determination. As one example of a product in this area, Bently Nevada has developed Machine Condition Manager™ 2000 (Machine Condition Manager is a trademark of Bently Nevada Corporation) using Gensym Corporation's G2™ (G2 is a trademark of Gensym Corporation) product.

An earlier important publication in this area of technology was the Dissertation “Classification of Vibration Signals By Methods of Fuzzy Pattern Recognition” (Klassifikation von Schwingungssignalen mit Methoden der unscharfen Mustererkennung”) by Dr. J. Strackeljan (a named inventor in this application) on Jun. 4, 1993 at the Technical University of Clausthal; this publication is incorporated herein by reference. The work describes an approach and a formalized methodology for a feature extraction process and classification algorithm as a basic element in a new type of integrated system for machine diagnosis and machine operation decision support. Other earlier feature selection publications of note are:

Chang, C., “Dynamic Programming as applied to Feature Subset Selection in a Pattern Recognition System”, IEEE Transactions on Systems, Man and Cybernetics, 1973, No. 3, S.166-171;

Chien, Y. T., “Selection and Ordering of Feature Observations in a Pattern Recognition System”, Information and Control, 1968, No. 12, pp.394-414;

Fu, K. S., “Sequential Methods in Pattern Recognition and Machine learning”, Academic Press, New York, 1968;

Fukunaga, K., “Repression of Random Processes using finite Karhuen-Loewe-Expansion”, Information and Control, Vol. 16, 1970, S. 85--101; and

Fukunaga, K., “Systematic Feature Extraction”, IEEE Transactions on pattern Analyses, Nr. 3, 1982.

One of the needs in use of classification systems relates to handling of anomalous measurements which do not initially appear to belong to any predefined status class. There is also a need for a machine diagnosis system which can be configured to diagnose a particular machine within a few days of the date of installation of the machine. Another emerging need in the art is for an approach which assimilates very large classification feature sets as the number of sensors (and the affiliated number of derived classification features) which can be simultaneously monitored by one CPU continues to increase. There is also an ongoing need for new feature types so that the diagnostic facility of the systems is rendered from an ever-improving datalogical reference frame. The Strackeljan Dissertation describes an approach for rapidly and efficiently resolving a large number of predictive features into a usefully defined subset of those features; this efficient approach is valuable in providing a basis for a system which can adapt its learning set in response to anomalous measurements even as it continues to provide real-time classification services. The present invention incorporates the approach described in the Strackeljan thesis along with further developments in providing solutions to all of the above-identified needs.

Further features and details of the invention are appreciated from a study of the Figures and Detailed Description of the Preferred Embodiments.

### SUMMARY OF THE INVENTION

The invention provides a computer-implemented method for monitoring a sensor and related machine component in a mechanical component assembly, through:

providing a predetermined set of candidate data features for classifying said sensor respective to at least two defined classes;

measuring in real-time an input signal from the sensor;

determining a first computer-determined class affiliation parameter value for the input signal from the candidate data feature set in reference to a first classifying parameter set respective to a first class;

determining a second computer-determined class affiliation parameter value for the input signal from the candidate data feature set in reference to a second classifying parameter set respective to a second class;

deriving, during the real-time measuring and determining steps, a third classifying parameter set for the input signal respective to the first class and a fourth classifying parameter set for the input signal respective to the second class when all computer-determined class affiliation parameter values respective to an input signal measurement in real-time have a quantity less than a predetermined threshold value, the third and fourth classifying parameter sets incorporating the influence of the input signal measurement; and

replacing the first and second classifying parameter sets respectively with the third and fourth classifying parameter sets so that the third and fourth classifying parameter sets respectively become the new first and second classifying parameter sets when the third and fourth classifying parameter sets have been derived.

The invention also provides a dimensionless peak amplitude data feature and a dimensionless peak separation data feature for use in classifying. An organized datalogical toolbox for operational component status classification is also provided.

Other features, advantages, and benefits of the invention are readily apparent from the detailed description of the preferred embodiments when taken in connection with the accompanying drawings.

### BRIEF DESCRIPTION OF THE DRAWINGS

FIG. 1 presents a block diagram of the monitoring system and auxiliary systems as they operate and monitor a manufacturing apparatus.

FIG. 2 shows detail in the galvanic isolation and signal filtering board.

FIG. 3 shows the band pass filter circuit used on the galvanic isolation and signal filtering board.

FIG. 4 presents a block flow overview of key logical components of the monitoring system.

FIG. 5 presents a block flow overview of signal conditioning logical components of the monitoring system.

FIG. 6 presents a block flow diagram of the real-time executive logic in the monitoring system.

FIG. 7 presents detail of functions performed at the direction of the real-time control block.

FIG. 8 presents a block flow diagram of the human interface logic in the monitoring system.

FIGS. 9A and 9B present a block flow diagram of the pattern recognition logic in the monitoring system.

FIG. 10 presents detail in a decision function set of the pattern recognition logic.

FIG. 11 presents a block flow diagram of the signal and data I/O and logging logic in the monitoring system.

FIG. 12 presents detail in the tool-specific feature derivation functions.

FIG. 13 presents a block flow diagram of the reference data logic in the monitoring system.

FIG. 14 presents details for a machine analysis toolbox.

FIG. 15 presents an overview flowchart of the organization of key information in constructing and using preferred embodiments.

FIG. 16 presents a flowchart of key classification steps.

FIG. 17 presents a flowchart detailing decisions in use of progressive feature selection, evolutionary feature selection, neural network classification, and weighted distance classification.

FIG. 18 presents detail in the weighted distance method of classifying and progressive feature selection.

FIG. 19 illustrates auxiliary detail in the progressive feature selection process of FIG. 18.

FIG. 20 presents detail in the neural network method of classifying and in evolutionary feature selection.

FIGS. 21A-21D illustrate detail in an evolutionary feature selection example.

FIG. 22 presents an overview of interactive methods and data schema in the preferred embodiments for use of the weighted distance classification method and a progressive feature selection methodology.

FIG. 23 presents an overview of interactive methods and data schema in the preferred embodiments for use of the neural network classification method and an evolutionary feature selection methodology.

FIG. 24 presents a unified mechanical assembly of machine components and attached sensors.

FIG. 25 presents a block flow summary showing toolbox development information flow for a particular set of unified mechanical assemblies and machine components.

FIG. 26 presents a view of key logical components, connections, and information flows in use of the monitoring system in a monitoring use of the preferred embodiment.

FIG. 27 presents a view of key logical components, connections, and information flows in use of the monitoring system in an adaptive control use of the preferred embodiment.

FIG. 28 shows an example of a graphical icon depiction of class affiliation parameter values in normalized form.

FIG. 29 shows an example of a graphical icon depiction of class affiliation parameter values in non-normalized form.

### DETAILED DESCRIPTION OF THE PREFERRED EMBODIMENTS

In describing the preferred embodiments, a number of “logical engines” (“engines”) are characterized in interaction with data structural elements. In this regard, computer-implemented logical engines generally reference virtual functional elements within the logic of a computer which primarily perform tasks which read data, write data, calculate data, and perform decision operations related to data. “Logical engines” (“engines”) optionally provide some limited data storage related to indicators, counters, and pointers, but most data storage within computer-implemented logic is facilitated within data structural elements (data schema) which hold data and information related to the use of the logic in a specific instance; these data structural element logical sections are frequently termed as “tables”, “databases”, “data sections”, “data commons”, and the like. Data structural elements are primarily dedicated to holding data instead of performing tasks on data and usually contain a generally-identified stored set of information. “Logical engines” (“engines”) within computer-implemented logic usually perform a generally identified function. As a design consideration, the use of both logical engines and logical tools within a logical system enables a useful separation of the logical system into focused or abstracted subcomponents which can each be efficiently considered, designed, studied, and enhanced within a separately focused and distinctively particularized context. As should be apparent, some of the logical internal systems represent distinctive areas of specialty in their own right, even as they are incorporated into the comprehensive and holistic system represented by each of the described embodiments. In one context, specific engines are individual executable files, linked files, and subroutine files which have been compiled into a unified logical entity. Alternatively, specific engines are combinations of individual executable files, linked files, subroutine files, and data files which are datalogically linked either in unified form or in a dynamically associated manner by the operating system during execution.

The specification also references the term “Real-Time” (real-time, real time, Real-time); to facilitate clarity, the following paragraph presents a discussion of the Real-Time concept.

Real-time computer processing is generically defined as a method of computer processing in which an event causes a given reaction within an actual time limit and wherein computer actions are specifically controlled within the context of and by external conditions and actual times. As an associated clarification in the realm of process control, real-time computer-controlled processing relates to the performance of associated process control logical, decision, and quantitative operations intrinsic to a process control decision program functioning to monitor and modify a controlled apparatus implementing a real-time process wherein the process control decision program is periodically executed with fairly high frequency usually having a period of between 10 ms and 2 seconds, although other time periods are also utilized. In the case of “advanced” control routines (such as the classifier of the described embodiments) where a single solution instance requires more extended computational time, a larger period is essentially necessary (frequency in determination of changes in control element settings should be executed at a frequency equal-to-or-less-than the frequency of relevant variable measurement); however, an extended period for resolution of a particular value used in control is still determined in real-time if its period of determination is repetitive on a reasonably predicable basis and is sufficient for utility in adaptive control of the operating mechanical assembly.

A measuring sensor attached to an apparatus usually outputs a voltage or voltage equivalent responsive to an attribute of the operational apparatus (e.g., an open valve or an energized pump) and/or conditions (e.g., fluid temperature or fluid pressure) in the materials operationally processed by the apparatus.

A signal (measured signal) represents the magnitude of the voltage either as a data value at a particular moment of time or, alternatively, as a set of data values where each data value has an explicit or implicit (via sequential ordering) association with a time attribute. The term “signal” in many instances also references the voltage or voltage history as converted to data value representation.

The signal is evaluated in the context of a function to derive specific signal function attributes; these signal attributes are also termed features (Features) both (a) as a descriptive term generally and also (b) as a reference variable in pattern-matching processes such as “classification”. In this regard, Features frequently reference a variable possessing a joining consideration or datalogical nexus between (a) an attribute derived in the context of a function from the measured signal and (b) a variable used in a classifier. A feature value generally represents a particular quantitative data value which has been assigned-to and associated-with a feature variable respective to a signal measurement instance.

Classifiers generally associate features—more specifically, patterns of features—with a membership (association, belonging, and/or affiliation) of the operational apparatus (generating the features) in a particular momentary status of identified useful categorization (a class); in this regard, membership is either (a) a designation, in one context, of belonging to the class or (b) a designation, in an alternative context, of not belonging to the class. Classes frequently are representative of human quality evaluations and/or judgements (e.g. a “good” class, a “bad” class, and/or a “transitional” class which represent, respectively, a “good” state of operational performance, a “bad” state of operational performance, and/or an “uncertain or transitioning” state of operational performance). Membership also references a degree of belonging to a class—e.g. in a two class evaluation, a degree of affiliation with the two classes is characterized as “the current state of the system is 90% ‘good’ and 10% ‘bad’”; more precisely, the concept of “sharpness” further references the quantitative confidence with which a particular classified measurement instance (in the context of its affiliated classifying feature set) is clearly affiliated with any class of the set of candidate classes for which membership is derived.

In classifying, Weighted Distance Classification and Euclidian Distance Classification reference certain overlapping situations; accordingly, references to Weighted Distance Classification herein implicitly includes appropriate use of Euclidian Distance Classification in the context of these similarities. In this regard, classification performance strongly depends on the ability of a particular classifier to adapt the distribution of a particular learning sample in an optimal manner. If a set of learning samples is represented in an essentially spherical distribution for all classes, the Euclidian metric is sometimes used. If the distribution is ellipsoidal, Weighted Distance approaches are optimal in coordinate directions weighted individually. In this regard, marginal samples are appraised similarly respective to different Euclidian distances. Essentially, the Euclidian metric is a special form of a Weighted Distance metric (when the weights are essentially equal for all directions); the inventors prefer, therefore, the use of a weighted distance classifier in general.

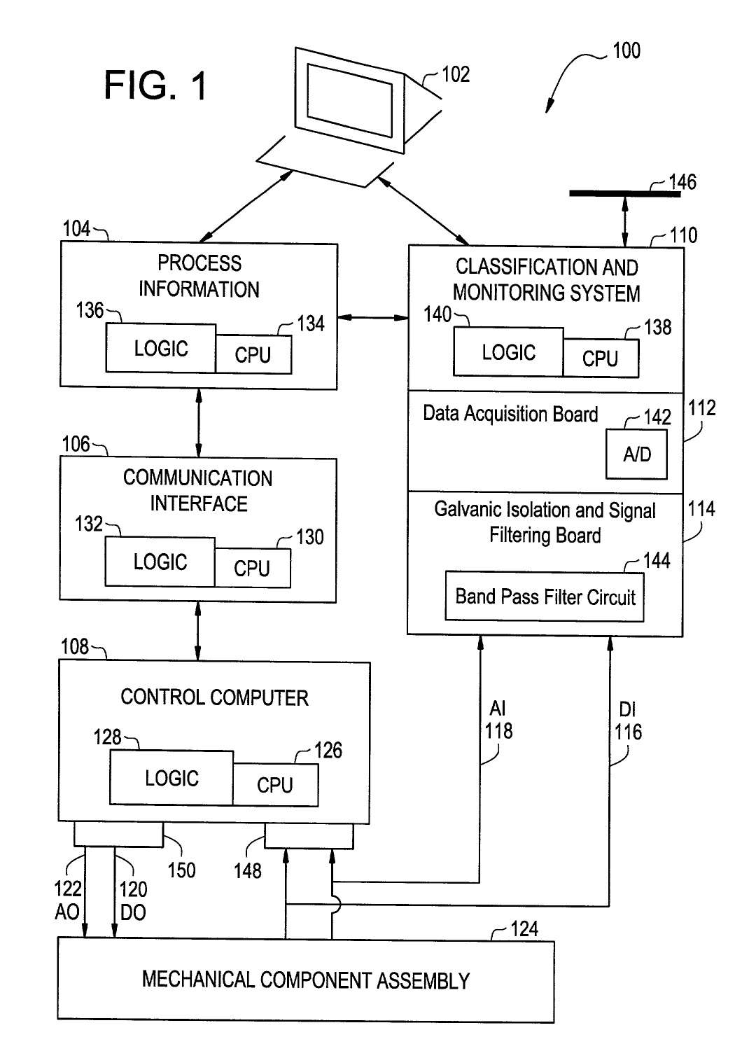

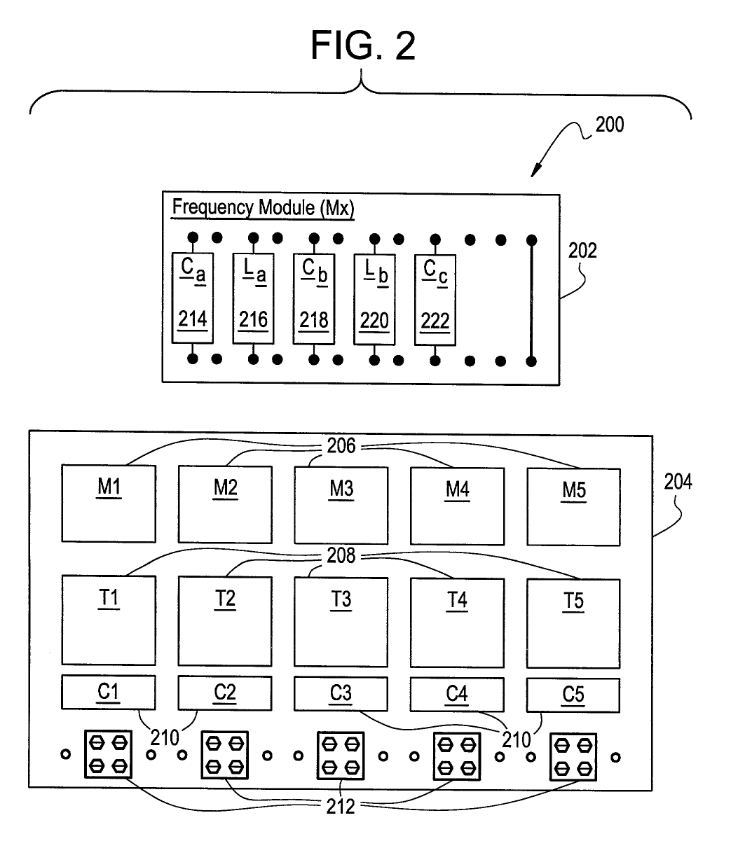

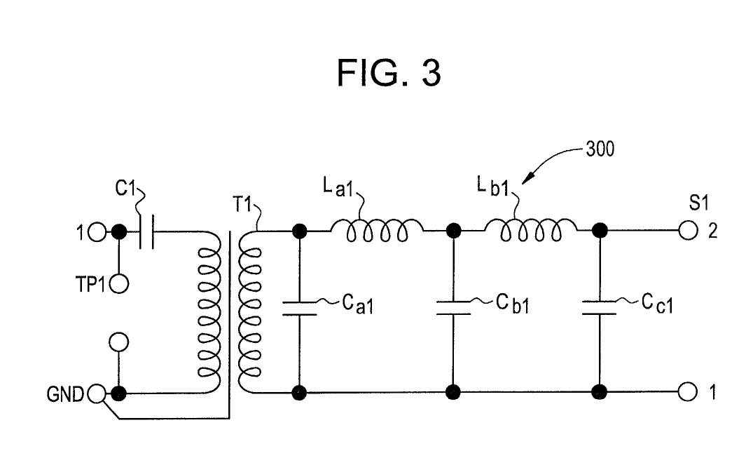

Turning now to the figures, FIG. 1 presents a block diagram of the monitoring system and auxiliary systems as they operate and monitor a manufacturing apparatus. System Overview 100 presents key physical components in an fully applied embodiment. Monitor 102 provides a monitor for human (operator technician and configuration expert) viewing of information and data. Process Information System 104 provides a process information system (a system for retaining and depicting information to operating technicians about data executing in an affiliated, attached, and interconnected real-time control system or group of real-time control systems but which is not under the highly rigorous real-time response cadence of a real-time control system for its communications) in bilateral data communication via Communications Interface 106 with Control Computer 108. Process Information System 104 incorporates Process Information CPU 134 for execution of Process Information Logic 136. Communications Interface 106 incorporates Communication Interface CPU 130 for execution of Communication Interface Logic 132. Control Computer 108 incorporates Control Computer CPU 126 for execution of Control Computer Logic 128 in real-time operational monitoring and control of Mechanical Assembly 124. Classification Computer System 110 provides Classification Computer CPU 138 for executing Classification Computer Logic 140 in implementing classification of the status of Mechanical Assembly 124. System Overview 100 is in bilateral data communication with Process Information System 104 for receiving a portion of input data as a data stream and for communicating the classification status of Mechanical Assembly 124 to Control Computer 108 so that Control Computer 108 controls Mechanical Assembly 124 in adaptive response to the classified status. Classification Computer System 110 also receives input data from Analog Input Signal 118 and Digital Input Signal 116 via Signal Filtering Board 114 and Data Acquisition Board 112. Data Acquisition Board 112 incorporates Analog-to-Digital-Converter Circuit 142 to effect conversion of analog voltages from Signal Filtering Board 114 into digital data. Signal Filtering Board 114 incorporates Band-Pass-Filter Circuit 144 as further described in Filter Circuit Components 200 and Filter Circuit 300 of FIGS. 2 and 3. Digital Input Signal 116 is provided both as a direct signal to Signal Filtering Board 114 and to Control Signal Input Circuitry 148 where Control Signal Input Circuitry 148 is synchronous with the needs of Control Computer 108. Analog Input Signal 118 is provided both as a direct signal to Signal Filtering Board 114 and to Control Signal Input Circuitry 148 where Control Signal Input Circuitry 148 is appropriately synchronous with Control Computer 108. Digital Output Signal 120 and Analog Output Signal 122 provide output command signals from Control Signal Output Circuitry 150 to Mechanical Assembly 124 so that Control Computer 108 implements manipulated variables to modify attributes of Mechanical Assembly 124 and thereby control the operation of Mechanical Assembly 124 in real-time. An example of Control Computer 108 is described in WO Publication No. 00/65415, dated Nov. 2, 2000, entitled “PROCESS CONTROL SYSTEM WITH INTEGRATED SAFETY CONTROL SYSTEM”, which is incorporated herein by reference.

Mechanical Assembly 124 is a mechanical component assembly, which benefits from Classification Computer System 110 (1) by the provision of information to an operating technician of the classified status of the operating assembly and (2), optionally, by the incorporation of the classified status into control decisions effected by Control Computer Logic 128. The classified status is communicated to Control Computer Logic 128 via Process Information System 104 and Communications Interface 106. Mechanical Assembly 124 is, alternatively, in example and without limitation, a motor, a gearbox, a centrifuge, a steam turbine, a gas turbine, a gas turbine operating with the benefit of wet compression, a chemical process, an internal combustion engine, a wheel, a furnace, a transmission, or an axle. With respect to wet compression, U.S. Pat. No. 5,867,977 for a “Method and Apparatus for Achieving Power Augmentation in Gas Turbines via Wet Compression” which issued on Feb. 9, 1999 to Richard Zachary and Roger Hudson and also U.S. Pat. No. 5,930,990 which issued on Aug. 3, 1999 to the same inventors provide a useful teaching of a gas turbine operating with the benefit of wet compression; these two patents are incorporated herein by reference.

Network 146 is in bilateral data communication with Classification Computer System 110 and provides an interface via network with other systems. In an alternative embodiment, Process Information System 104 interfaces with Classification Computer System 110 via Network 146; in a further alternative embodiment, Communications Interface 106 interfaces with Classification Computer System 110 via Network 146. Control Signal Input Circuitry 148 generically references a set of circuits which are respectively specific to Digital Input Signal 116 and Analog Input Signal 118 in interfacing to Control Computer 108.

Details in Process Information System 104, Communications Interface 106, Control Computer 108, Network 146, and Data Acquisition Board 112 should be apparent to those of skill and are presented here briefly to enable a framed understanding of preferred embodiments and their use. Details in Classification Computer Logic 140 and Signal Filtering Board 114 are focal in most subsequent discussion in this specification.

FIG. 2 shows detail in the galvanic isolation and signal filtering board. Filter Circuit Components 200 shows further detail in Signal Filtering Board 114. Frequency Module 202 presents construction details in Frequency Modules 206. Band-Pass-Filter Circuitry Board 204 shows an embodiment of Signal Filtering Board 114 with a set of Frequency Modules 206, a set of Transformers 208, and a set of Input Capacitors 210 in electrical mounting as shown. As previously noted, a instance of Frequency Modules 206 is further detailed in Frequency Module 202 which is provided in 5 separate instances on Band-Pass-Filter Circuitry Board 204. Transformer 208 is provided in 5 separate instances on Band-Pass-Filter Circuitry Board 204. Input Capacitors 210 are also provided in 5 separate instances on Band-Pass-Filter Circuitry Board 204. Signal Wire Terminators 212 provide 5 separate wiring terminations for use in interfacing 5 separate instances of Analog Input Signal 118 to Data Acquisition Board 112. It should be noted that Digital Input Signal 116 is optionally routed in a pass-through manner to Classification Computer System 110 via Signal Filtering Board 114 and Data Acquisition Board 112, but most signals used by Classification Computer System 110 are of the Analog Input Signal 118 type. Frequency Capacitor “a” 214, Frequency Capacitor “b” 218, and Frequency Capacitor “c” 222 provide respective first, second, and third capacitors in Frequency Module 202. Frequency Inductor “a” 216 and Frequency Inductor “b” 220 provide respective first and second inductors in Frequency Module 202.

FIG. 3 shows the band pass filter circuit used on the galvanic isolation and signal filtering board. Filter Circuit 300 shows one band pass filter circuit which is established by the combination of Input Capacitors 210 instance C1, Transformers 208 instance T1, and Frequency Modules 206 instance M1 with Cₐ₁ mapping to Frequency Capacitor “a” 214, Lₐ₁ mapping to Frequency Inductor “a” 216, C_{b1} mapping to Frequency Capacitor “b” 218, L_{b1} mapping to Frequency Inductor “b” 220, and C_{c1} mapping to Frequency Capacitor “c” 222. These are preferably characterized according to the following criteria of Table 1:

TABLE 1

| Upper | | | | | |
|---|---|---|---|---|---|
| cut-off frequency: f_{g} = 2 Khz | | | Upper Cut-off Frequency f_{g} = 20 Khz | | |
| C210 | 10 μF/100 V | Lₐ 47 μH | C210 | 10 μF/100 V | Lₐ 47 μH |
| Cₐ | 330 nF/100 V | L_{b} 47 μH | Cₐ | 47 nF/100 V | L_{b} 47 μH |
| C_{b} | 330 nF/100 V | | C_{b} | 47 nF/100 V | |
| C_{c} | 330 nF/100 V | | C_{c} | 47 nF/100 V | |

| | |
|---|---|
| T208 | ST 6353 (signal transformer) |

Lₐ, L_{b}: Micro coils

In one embodiment having two instances of Band-Pass-Filter Circuitry Board 204, a beneficial arrangement of Band-Pass-Filter Circuit 144 instances is shown in Table 2.

TABLE 2
Band-Pass-Filter Circuit 144 Configuration

| I/O | | |
|---|---|---|
| Channel | | |
| 212 | Frequency | |
| S0 | 20 | Khz |
| S1 | 20 | Khz |
| S2 | 20 | Khz |
| S3 | 2 | Khz |
| S4 | 2 | Khz |
| S5 | 20 | Khz |
| S6 | 20 | Khz |
| S7 | 20 | Khz |
| S8 | 2 | Khz |
| S9 | 2 | Khz |

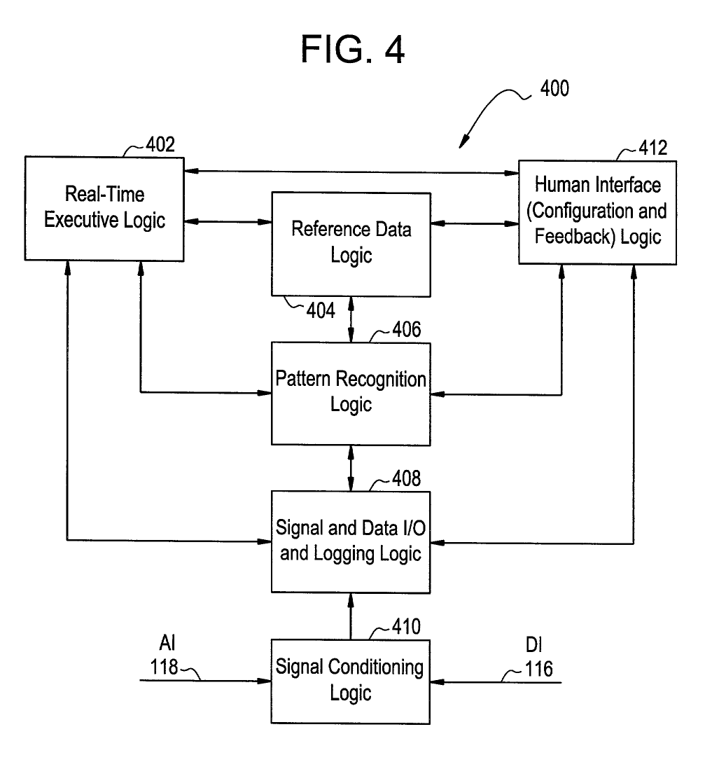

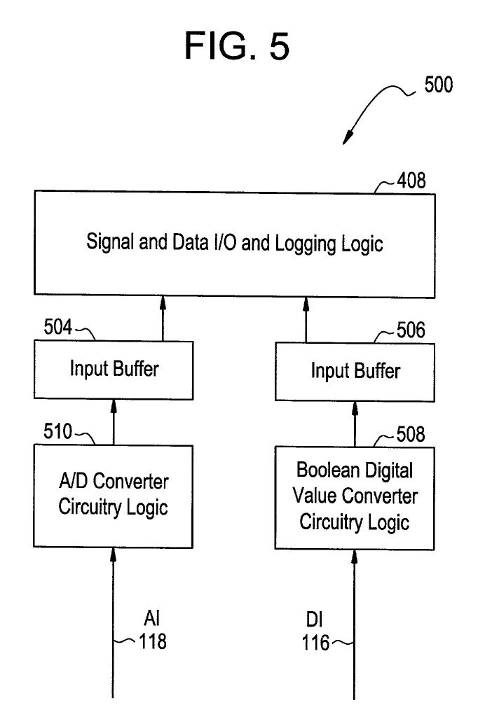

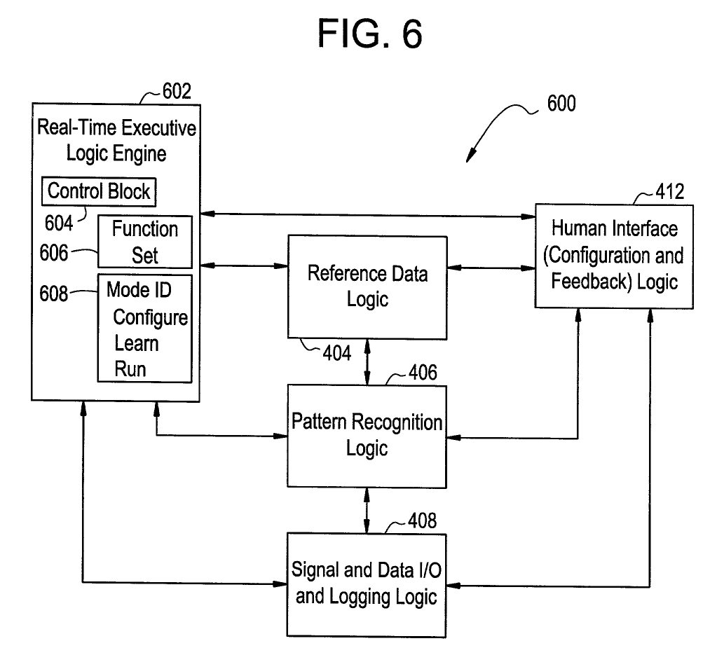

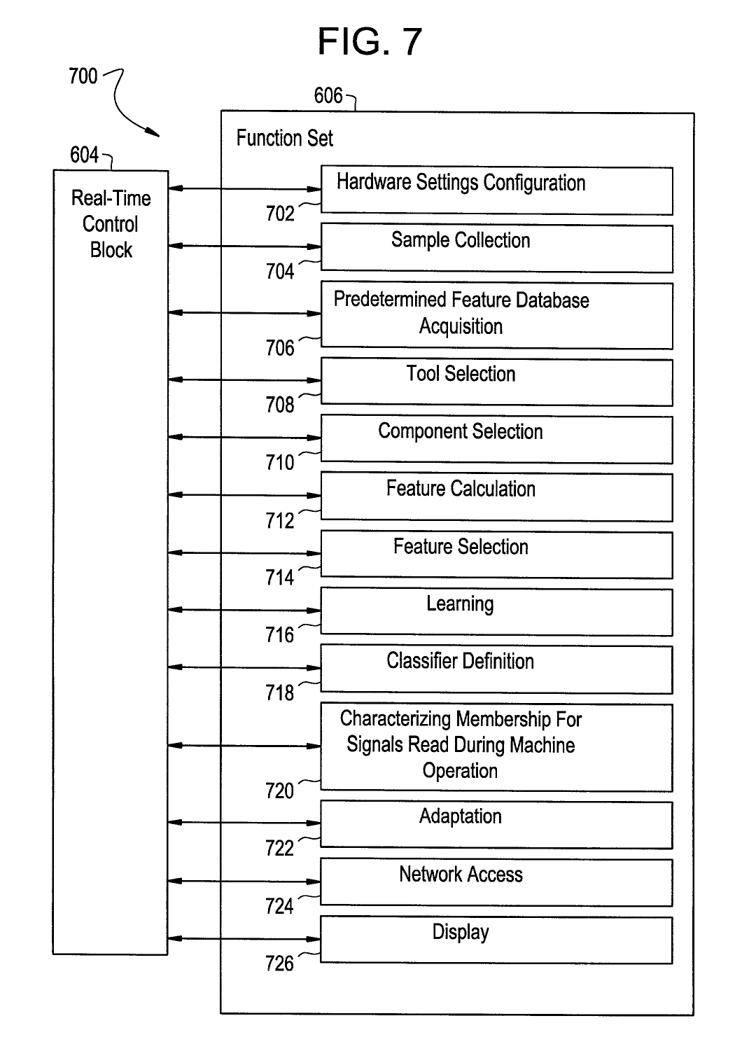

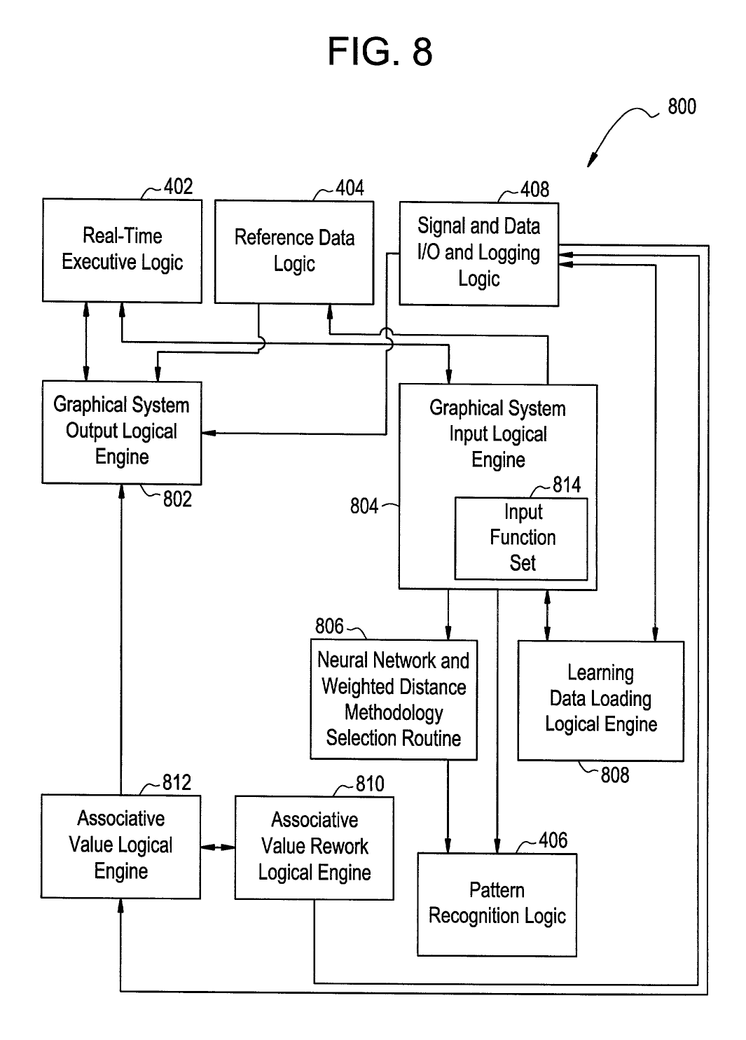

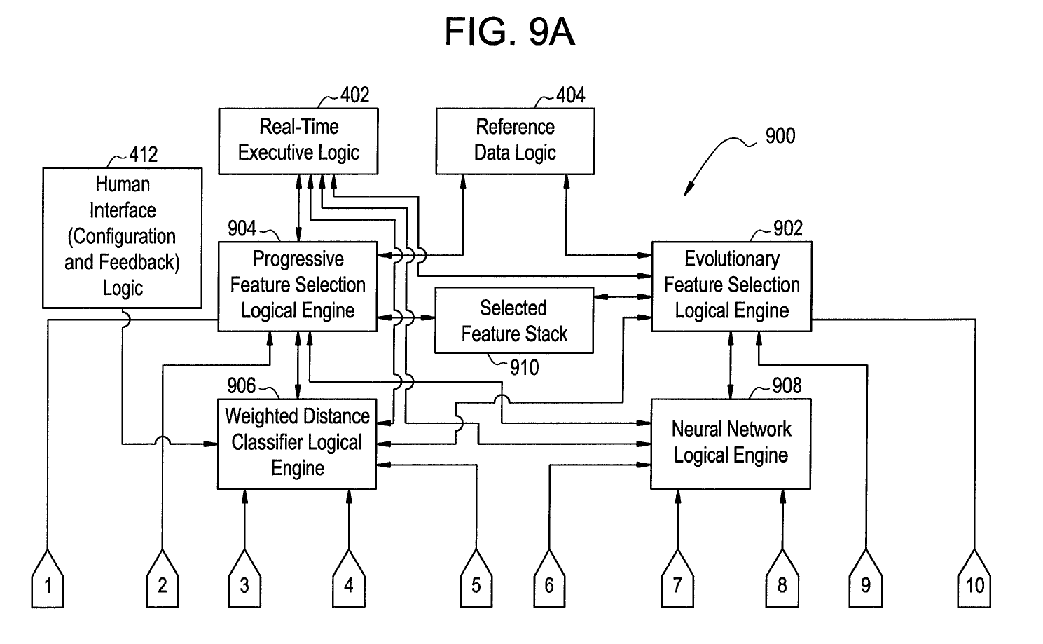

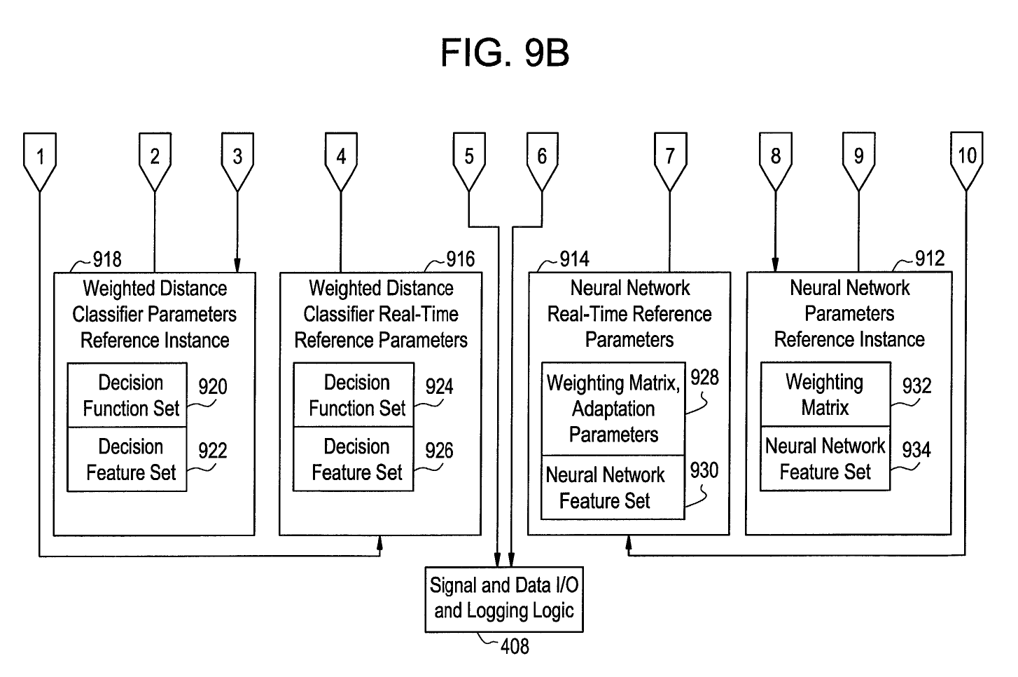

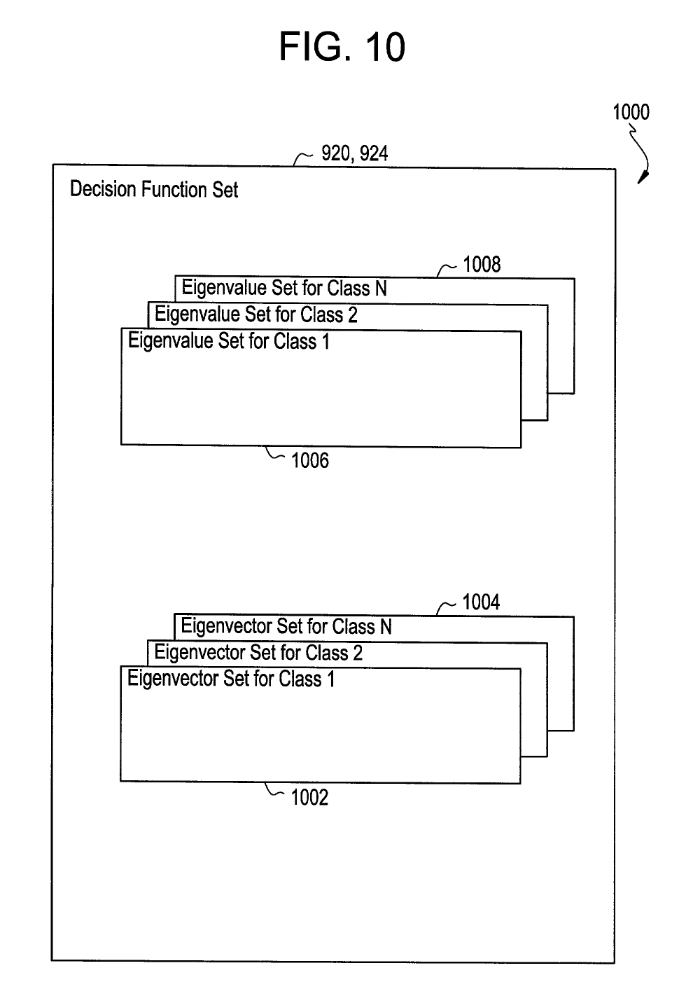

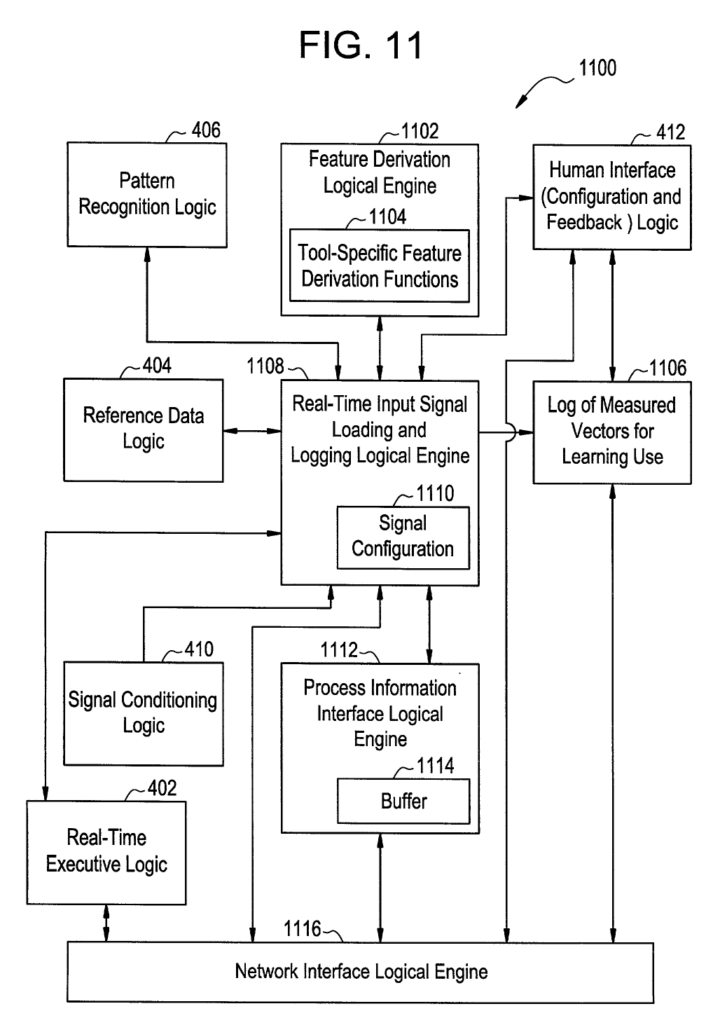

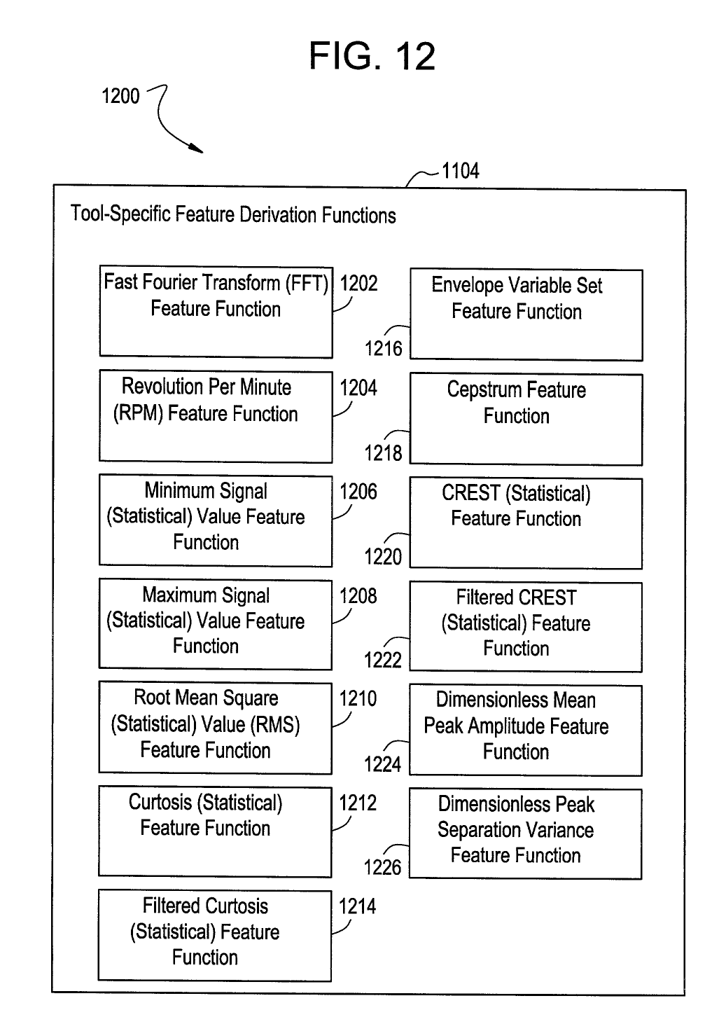

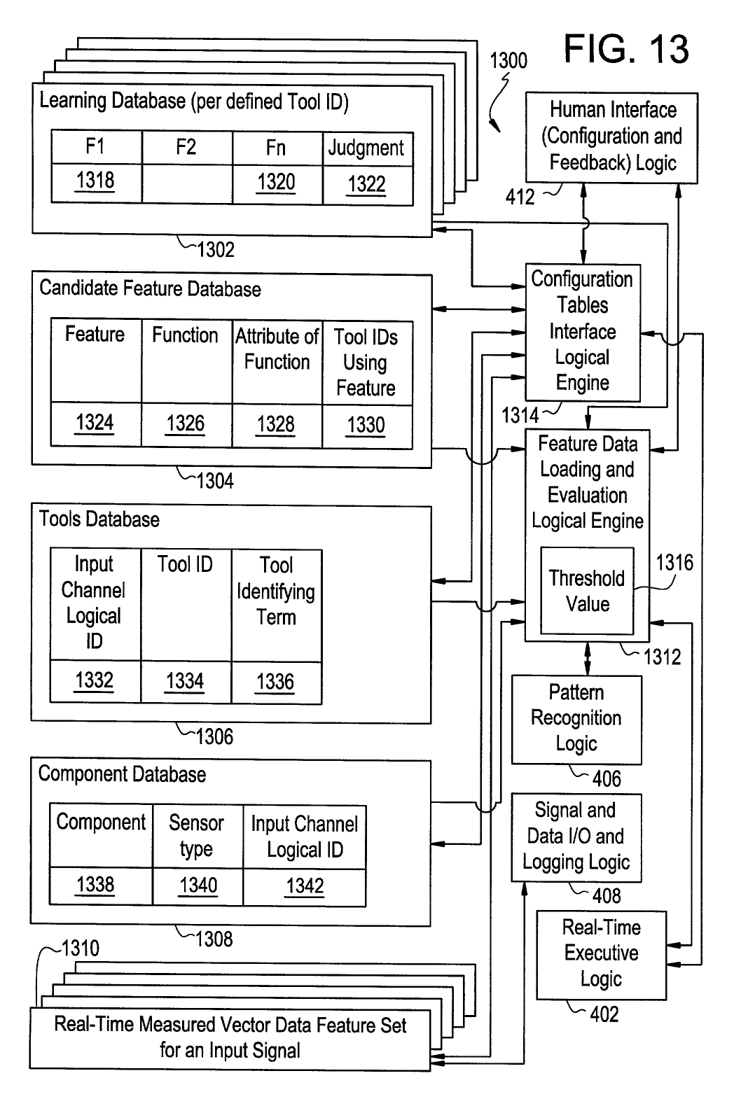

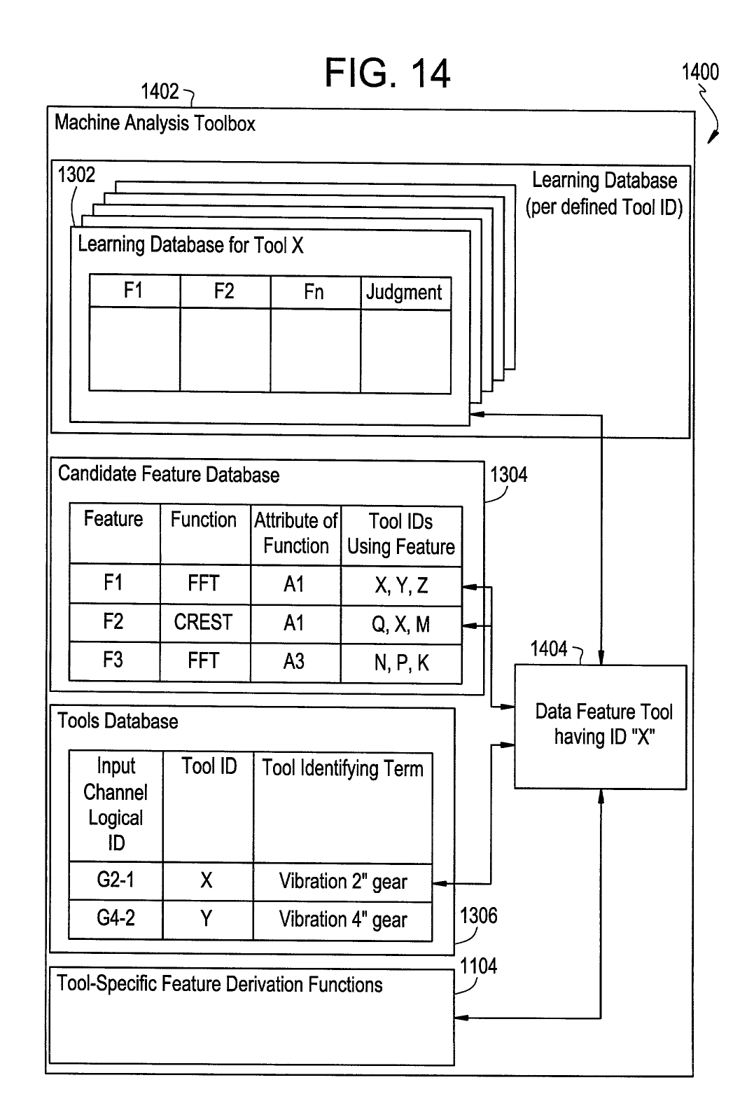

FIG. 4 presents a block flow overview of key logical components of the monitoring system. Classifying Logic 400 provides a first nested opening of Classification Computer Logic 140. Real-Time Executive Logic 402 is in bilateral data communication with Reference Data Logic 404, Human Interface Logic 412, Pattern Recognition Logic 406, and Signal I/O Logic 408 and is further discussed with respect to Real-Time Logic Detail 600 and Real-Time Function Detail 700 of FIGS. 6 and 7. As should be apparent, Real-Time Executive Logic 402 provides execution enablement data signals and multi-process and/or multitasking interrupts to all engines and other executable logic of Reference Data Logic 404, Human Interface Logic 412, Pattern Recognition Logic 406, and Signal I/O Logic 408 as needed and receives feedback and flagging inputs so that responsive logic is executed in a unified and coordinated real-time cadence. Reference Data Logic 404 also is in bilateral data communication with Human Interface Logic 412 and Pattern Recognition Logic 406 and is further discussed with respect to Reference Data Detail 1300 and Toolbox 1400 of FIGS. 13 and 14. Pattern Recognition Logic 406 also is in bilateral data communication with Signal I/O Logic 408 and Human Interface Logic 412 and is further discussed with respect to Pattern Recognition Logic Detail 900 and Decision Function Detail 1000 of FIGS. 9A, 9B, and 10. Signal I/O Logic 408 also is in bilateral data communication with Human Interface Logic 412 and is in data reading communication with Signal Conditioning Logic 410 and is further discussed with respect to Signal Logic Detail 1100 and Derivation Functions 1200 of FIGS. 11 and 12. Signal Conditioning Logic 410 reads Analog Input Signal 118 and Digital Input Signal 116 and provides values via read access to Signal I/O Logic 408; this logical section is further discussed respective to Signal Conditioning Detail 500 of FIG. 5. Human Interface Logic 412 interfaces to Monitor 102 to provide an interface with operating technicians; this logic is further detailed in the discussion respective to Interface Logic Detail 800 of FIG. 8.

FIG. 5 presents a block flow overview of signal conditioning logical components of the monitoring system. Signal Conditioning Detail 500 provides further detail in Signal Conditioning Logic 410 and also reprises Signal I/O Logic 408 along with Analog Input Signal 118 and Digital Input Signal 116 for reference. Analog Signal Input Buffer 504 holds data from Analog Value Input Logic 510 so that Signal I/O Logic 408 can read the data in a timely manner. Digital Signal Input Buffer 506 holds data from Digital Value Input Logic 508 so that Signal I/O Logic 408 can read the data in a timely manner. Digital Value Input Logic 508 provides a logical engine for real-time acquisition of Digital Input Signal 116 and interface of Digital Input Signal 116 to Digital Signal Input Buffer 506. It is again noted that use of Digital Input Signal 116 is relatively minimal at this time in the described embodiments, but use of Digital Input Signal 116 signals is certainly possible in certain contemplated circumstances (e.g., without limitation, a machine “trip” indicator). The Analog Value Input Logic 510 engine provides logic necessary for real-time operation of Analog-to-Digital-Converter Circuit 142 and interface of Analog Input Signal 118 to Analog Signal Input Buffer 504.

FIG. 6 presents a block flow diagram of the real-time executive logic in the monitoring system. Real-Time Logic Detail 600 provides further detail in Real-Time Executive Logic 402 and also reprises Reference Data Logic 404, Pattern Recognition Logic 406, Human Interface Logic 412, and Signal I/O Logic 408 for reference. Real-Time Executive Engine 602 contains Control Block 604 for providing cadenced execution of Classification Computer Logic 140. In this regard, Control Block 604 contains sub-logic for substantially directing Classification Computer CPU 138 to implement Classifying Logic 400 in achieving the goals of the classifying system using either multi-process or multi-tasking approaches. Control Block 604 interfaces with routines in Function Set 606 in implementation of Classification Computer Logic 140. Further detail in Function Set 606 is presented in the discussion with respect to Real-Time Function Detail 700 of FIG. 7. Control Block 604 is also responsive to status indicators as indicated in Mode ID 608. The “Configure”, “Learn”, and “Run” modes of operation are defined in one embodiment via input from Human Interface Logic 412 with human designation of the particular active mode at any particular time.

FIG. 7 presents detail of functions performed by use of the real-time control block. Real-Time Function Detail 700 shows further detail in Function Set 606. In this regard, the internal functions of Function Set 606 are in bilateral data communication (i.e., data read communication and data write communication in both directions as appropriate) with Control Block 604. Hardware Configuration Function 702 provides code in interfacing Human Interface Logic 412 to Signal I/O Logic 408 for configuring Classification Computer System 110 to a particular set of Analog Input Signals 118 and Digital Input Signals 116. Sample Collection Function 704 provides code in interfacing Human Interface Logic 412 and Signal I/O Logic 408 in acquiring sample data for use in customizing System Overview 100 to a particular Mechanical Assembly 124. Database Acquisition Function 706 provides code in interfacing Human Interface Logic 412 and Reference Data Logic 404 to load learning databases into system 110. Tool Selection Function 708 provides code in interfacing Human Interface Logic 412 and Reference Data Logic 404 to define tools for use with particular signals. Component Selection Function 710 provides code in interfacing Human Interface Logic 412 and Reference Data Logic 404 in defining components which can then define tools. Feature Calculation Function 712 provides code in interfacing Reference Data Logic 404 and Signal I/O Logic 408 to calculate features for use in Pattern Recognition Logic 406. Feature Selection Function 714 provides code in interfacing Reference Data Logic 404 and Pattern Recognition Logic 406 in selecting features for classification use. Learning Function 716 provides code in interfacing Reference Data Logic 404, Human Interface Logic 412, and Pattern Recognition Logic 406 in implementing a learning process to acquire a learning database. Classifier Definition Function 718 provides code in interfacing Reference Data Logic 404, Human Interface Logic 412, and Pattern Recognition Logic 406 in defining a classifier. Real-Time Characterization Function 720 provides code in interfacing Reference Data Logic 404, Signal I/O Logic 408, Pattern Recognition Logic 406, and Human Interface Logic 412 in implementing real-time membership value determinations to classify Mechanical Assembly 124 in operation. Adaptation Function 722 provides code in interfacing Human Interface Logic 412, Reference Data Logic 404, Pattern Recognition Logic 406, and Signal I/O Logic 408 in implementing adaptation of the classifying system in real-time to assimilate learning related to measured signals or data which are not classifiable to an acceptable confidence with the existing classifier. Network Interfacing Function 724 provides code in interfacing Signal I/O Logic 408 and Human Interface Logic 412 with Network 146 or Process Information System 104. Display Function 726 provides code in interfacing Signal I/O Logic 408 and Human Interface Logic 412 and further in interfacing Human Interface Logic 412 and Monitor 102 so that an operating technician is apprised of the classification status of Mechanical Assembly 124 in operation.

FIG. 8 presents a block flow diagram of the human interface logic in the monitoring system. Interface Logic Detail 800 presents expanded detail of Human Interface Logic 412. Real-Time Executive Logic 402, Reference Data Logic 404, Signal I/O Logic 408, and Pattern Recognition Logic 406 are reprised from FIG. 4. Graphical Output Engine 802 is in bilateral data communication with Real-Time Executive Logic 402 for (1) data write communicating the occurrence of anomalous measured vectors (to Adaptation Function 722) as determined by Rework Engine 810 (and communicated from Associative Value Engine 812), (2) data read communication from functions in Function Set 606 which output information to the operating technician, and (3) receipt of multi-process and/or multitasking interrupts and execution enablement data signals from Real-Time Executive Logic 402. Graphical Output Engine 802 is in data reading communication with Signal I/O Logic 408, Reference Data Logic 404, and Associative Value Engine 812 so that data from these sections is output to the operating technician. Graphical Input Engine 804 interfaces the keyboard or other input device associated with Monitor 102 in bilateral data communication with Real-Time Executive Logic 402 for execution-enablement data signals, multi-process and/or multitasking interrupts, and data input to Function Set 606 and Mode ID 608. Graphical Input Engine 804 is in data writing communication with Reference Data Logic 404, Pattern Recognition Logic 406, and Characterization Selection Routine 806 so that data is input from the operating technician to these logical sections as needed. Graphical Input Engine 804 also is in bilateral data communication with Learning Data Loading Engine 808 to facilitate operating technician activation of loading of learning database data and toolbox data (discussion with respect to FIGS. 13 and 14) into Signal I/O Logic 408 and Reference Data Logic 404. Graphical Input Engine 804 optionally contains Input Function Set 814 for enabling particular data sets to be defined as a group for communication in a unified data write operation. Characterization Selection Routine 806 is in data reading communication with Graphical Input Engine 804 and is in data writing communication with Pattern Recognition Logic 406 to enable operating technician selection of either a Neural Network or Weighted Distance Classifier for use in classification. Learning Data Loading Engine 808 interfaces to Signal I/O Logic 408 for networked data or to a disk or CD-ROM (not shown) in Classification Computer System 110 in loading of learning database data and toolbox data into Signal I/O Logic 408 and Reference Data Logic 404. Rework Engine 810 is in bilateral data communication with Associative Value Engine 812 in evaluating memberships determined in Associative Value Engine 812 as part of identifying anomalous measured vectors and notifying Real-Time Executive Logic 402 as described above. Rework Engine 810 also is in data writing communication with Signal I/O Logic 408 for flagging retention of anomalous measurements to the attention of the operating technician. Associative Value Engine 812 is in data reading communication with Signal I/O Logic 408 for receiving membership values and determining appropriate membership value display data (e.g., without limitation, basic or normalized form). Associative Value Engine 812 is in bilateral data communication with Rework Engine 810 and is in data writing communication with Graphical Output Engine 802 for purposes previously discussed.

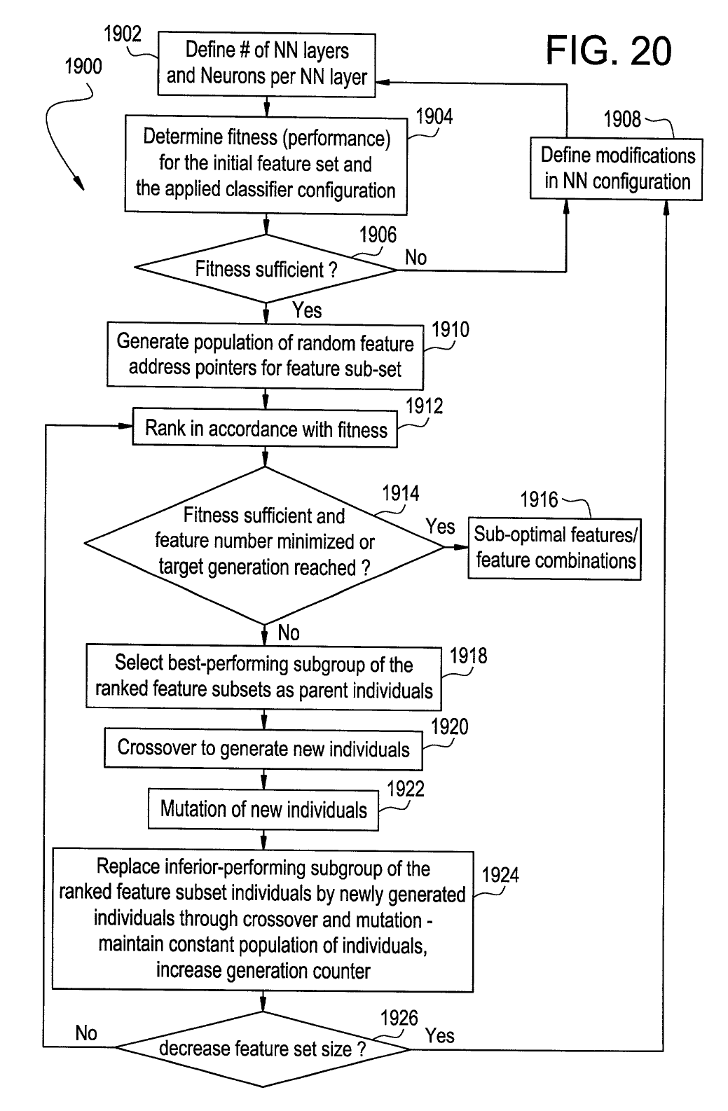

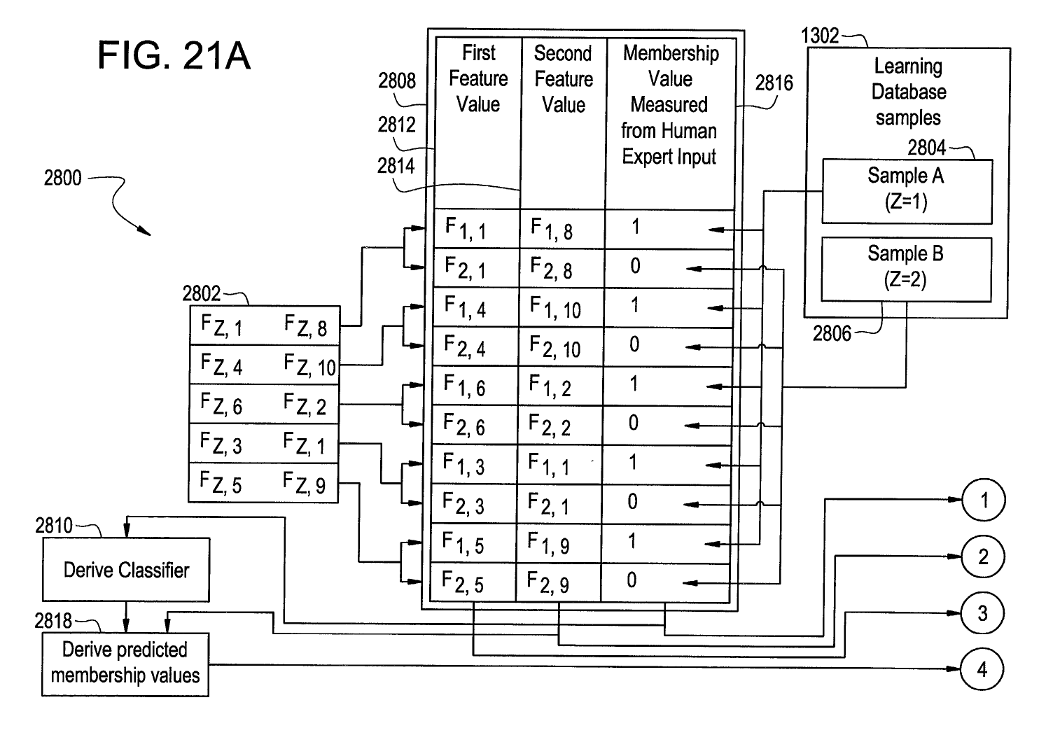

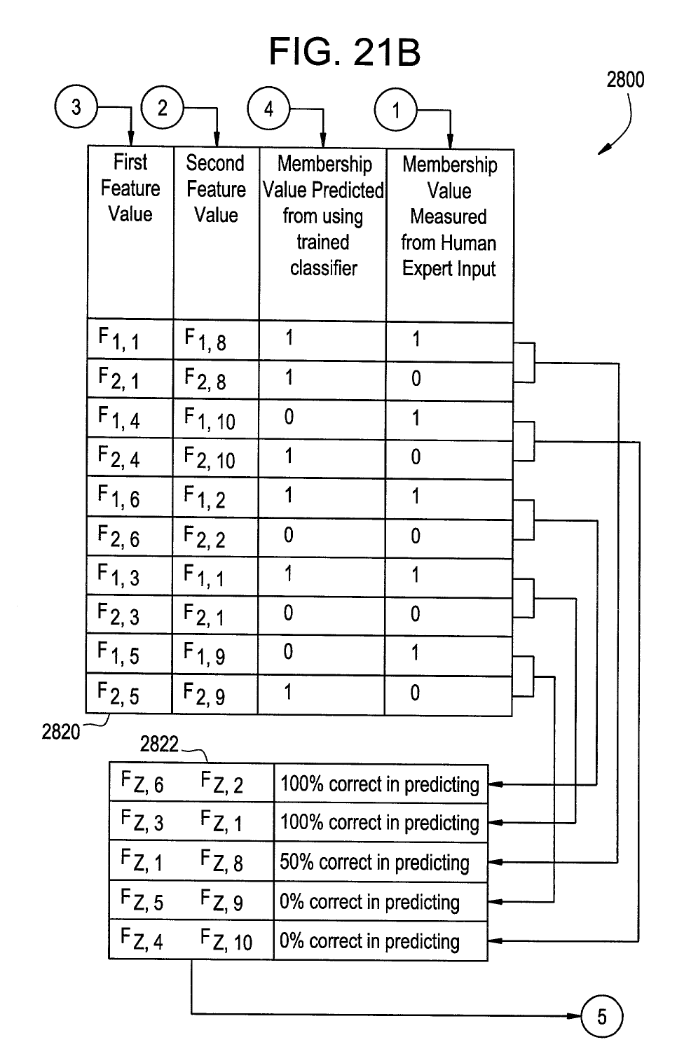

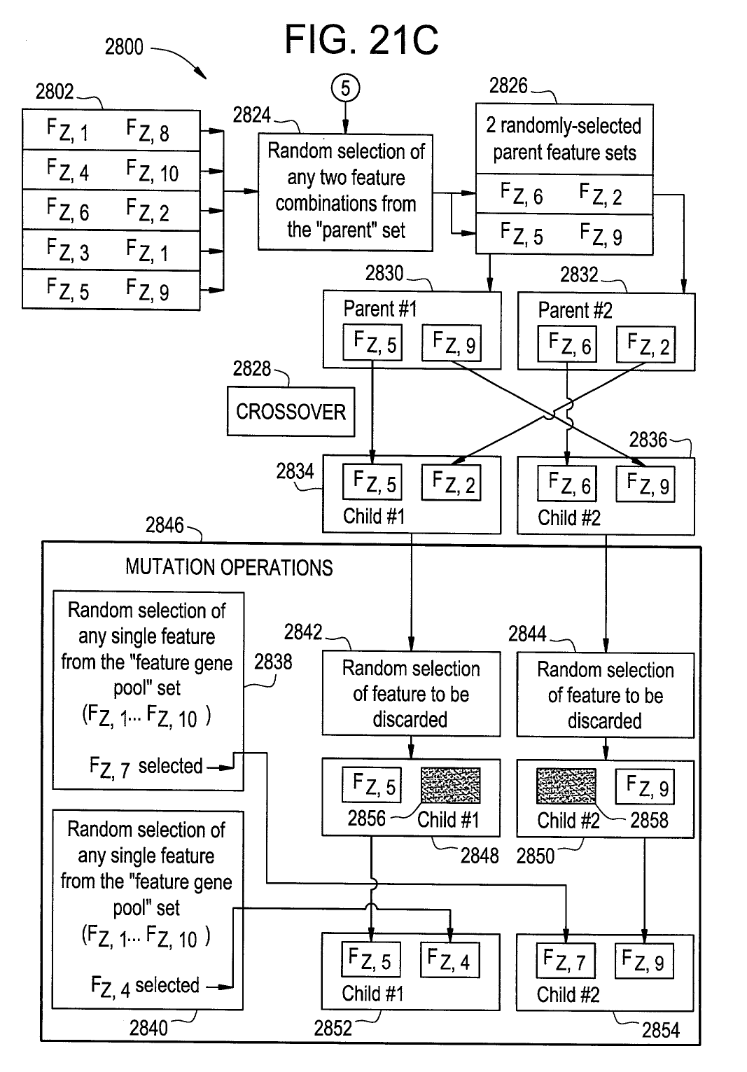

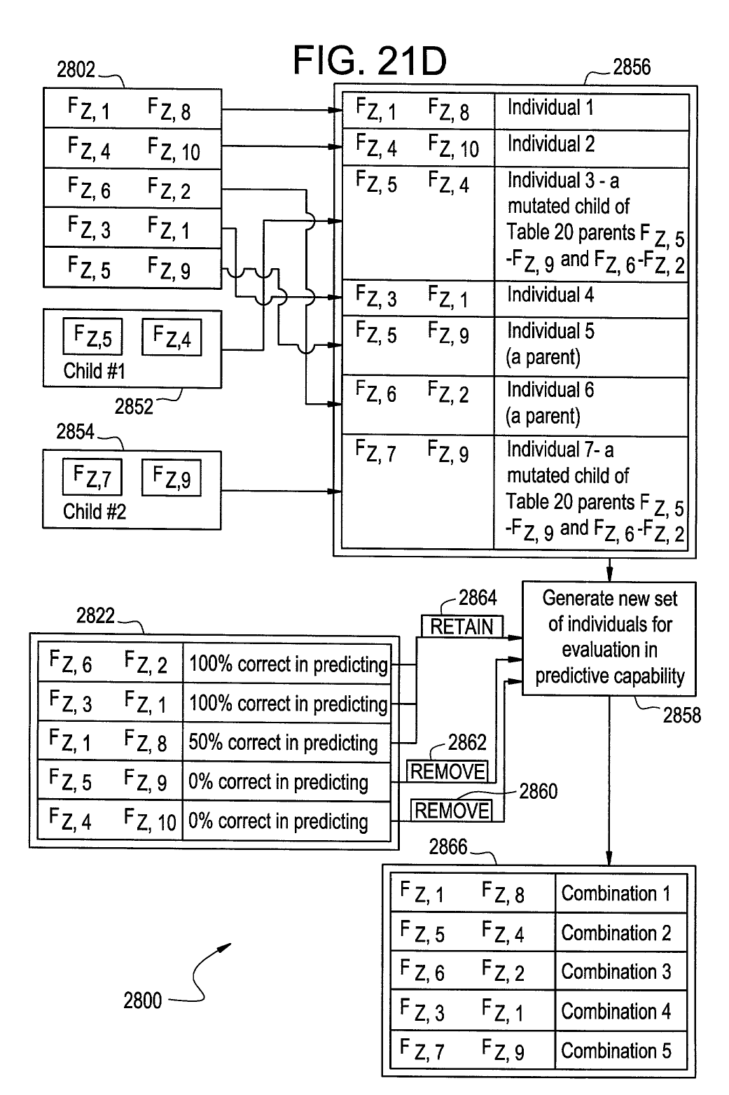

FIGS. 9A and 9B present a block flow diagram of the pattern recognition logic in the monitoring system. Pattern Recognition Logic Detail 900 presents detail in Pattern Recognition Logic 406. Signal I/O Logic 408, Reference Data Logic 404, Real-Time Executive Logic 402, and Human Interface Logic 412 are reprised from FIG. 4. Evolutionary Feature Selector 902 is in bilateral data communication with Reference Data Logic 404 for receiving learned data and toolbox data (FIGS. 13 and 14) needed in defining a set of features for use in classification. Evolutionary Feature Selector 902 implements random selection of a plurality of feature sets where each individual set of features is then used by Weighted Distance Classifier 906 or Neural Net Engine 908 in defining a classifier; the classifier is then used to evaluate the memberships of individual test measurements; the evaluations are then compared to judgments from a human expert to define the most acceptable sets of features in the plurality of feature sets. The most acceptable feature sets are then either enhanced or randomly cross-mutated (FIGS. 21A-21D) on a feature-by-feature basis to define a new plurality of feature sets. When an acceptable threshold of classification confidence is achieved, the feature set achieving the threshold is then used to classify Mechanical Assembly 124. A further discussion of the evolutionary operation of Evolutionary Feature Selector 902 is presented in the discussions of Evolutionary Feature Selection Process 1900 of FIG. 20 and in the Example illustrated by FIGS. 21A-21D. Evolutionary Feature Selector 902 is in bilateral data communication with Selected Feature Stack 910 to store most acceptable feature sets; Evolutionary Feature Selector 902 is in bilateral data communication with Neural Net Engine 908 and Weighted Distance Classifier 906 for classifying feature sets and evaluating results. Evolutionary Feature Selector 902 is in data reading communication with neural network Parameter Instance 912 and in data writing communication with NN Real-Time Parameters 914 for reading and storing the final selected set of features and classification reference parameters (weighting matrix and adaptation parameters) for real-time use. As should also be apparent, Evolutionary Feature Selector 902 is in bilateral data communication with Real-Time Executive Logic 402 for execution enablement data signals, multi-process and/or multitasking interrupts, and data input to Function Set 606.

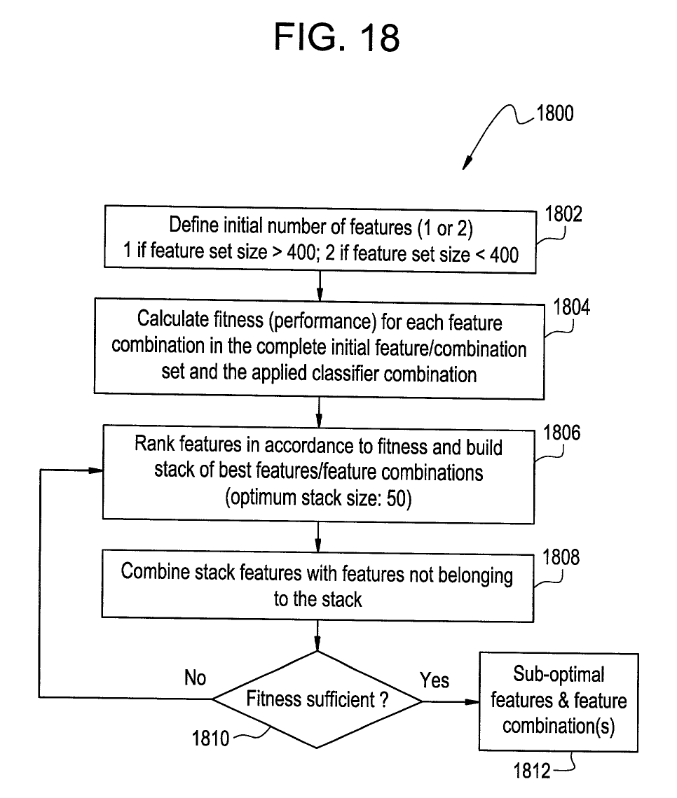

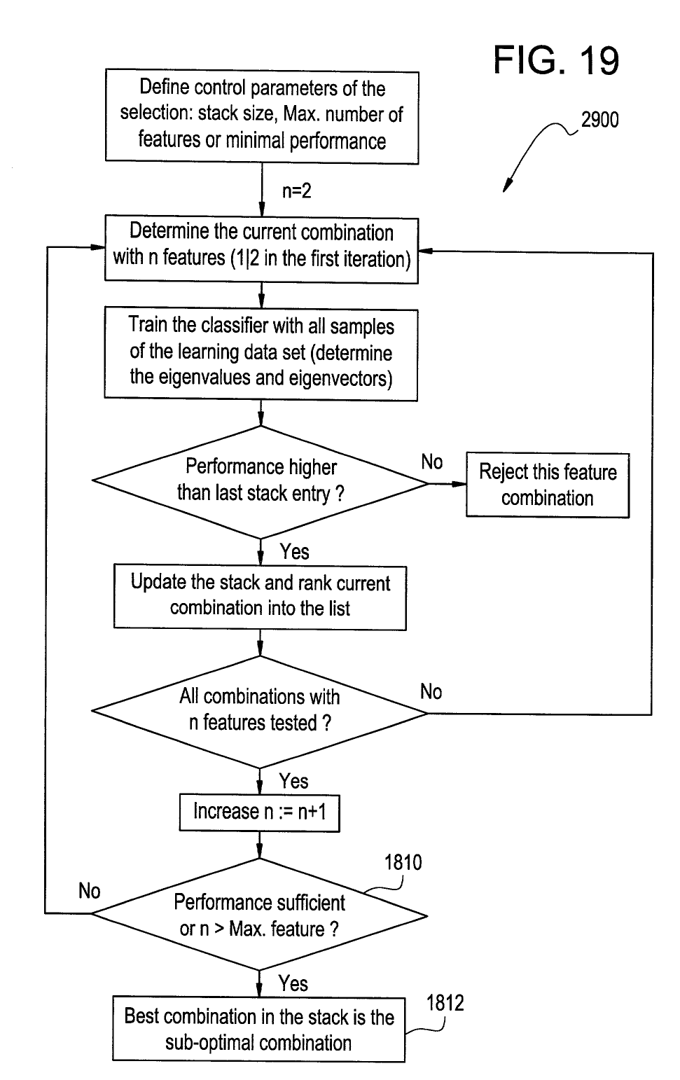

Progressive Feature Selector 904 is in bilateral data communication with Reference Data Logic 404 for receiving learned data and other toolbox data needed in defining a set of features for use in classification. Progressive Feature Selector 904 implements a routine of progressively evaluating an iteratively decreased plurality of feature sets where each set of features is used by Weighted Distance Classifier 906 or Neural Net Engine 908 in defining a classifier; the classifier is then used to evaluate the memberships of individual test measurements; and the evaluations are then compared to judgments from a human expert to define the most acceptable sets of features in the plurality of feature sets. The features of the most acceptable feature set are then enhanced with features not in the acceptable set to define a new plurality of feature sets. When an acceptable threshold of classification confidence is achieved, the feature set achieving the threshold is then used to classify Mechanical Assembly 124. A further discussion of the progressive selection operation of Progressive Feature Selector 904 is presented in discussion of Progressive Feature Selection Process 1800 of FIG. 18 and in auxiliary detail in FIG. 19. Progressive Feature Selector 904 is in bilateral data communication with Selected Feature Stack 910 to stack the most acceptable features during the process of evaluation; the stacking enables efficient use of memory in retaining the desired features. Progressive Feature Selector 904 is in bilateral data communication with Neural Net Engine 908 and Weighted Distance Classifier 906 for classifying feature sets and evaluating results. Progressive Feature Selector 904 is in data writing communication with Weighted Distance Real-Time Parameters 916 for storing the final selected set of features and classification reference parameters (decision function set and decision feature set) for real-time use. As should also be apparent, Progressive Feature Selector 904 is in bilateral data communication with Real-Time Executive Logic 402 for multi-process and/or multitasking interrupts, execution enablement data signals, and data input to Function Set 606.

Weighted Distance Classifier 906 is a weighted distance classifier as generally understood in the art. Examples of such classifiers are described in:

Bezdek, J. C., “Pattern Recognition with Fuzzy Objective Function Algorithm”, Plenum Press, New York, 1981;

Gath, I., “Unsupervised Optimal Fuzzy Clustering”, IEEE Trans, Pattern Analysis and Machine Intell., Juli 1989;

Jollife I. T., “Principle Component Analysis”, Springer Verlag 1986;

Kandal, A., “Fuzzy Techniques in Pattern Recognition”, John Wiley, New York, 1982;

Kittler, J., “Mathematical Methods of Feature Selection in Pattern Recognition”, International Journal on Man-Machine Studies, 1975, No. 7, S. 609-637;

Mahalanobis, P. C., “On the generalized distance in statistics”, Proc. Indian Nat. Inst. Sci. Calcutta, 1936, S. 49-55;

Watanabe, S., “Karhuen-Loewe Expansion and Factor Analysis”, Transactions 4th Prague Conference on Information Theory, 1965, S. 635-660;

Zimmermann, H. J., “Fuzzy Set Theory and its Applications”, Kluver Academic Publishers, 1991;

(Previously referenced) Strackeljan, J., “Klassifikation von Schwingungssignalen mit Methoden der unscharfen Mustererkennung”, Dissertation TU Clausthal, 1993; and

Strackeljan, J., Weber, R., “Quality Control and Maintenance”, In: Fuzzy Handbook Prade and Dubois, Vol. 7 Practical Applications of Fuzzy Technologies, Nov. 1999, Kluwer Academic Publisher.

Neural Net Engine 908 is a neural network classifier as generally understood in the art. An example of such a classifier is described in

Rumelhart, D. E., McClelland, J. L. and the PDP Research group, “Parallel Distributed Processing”, MIT Press, Cambridge, MA, 1986

and

Pao, Y. H., “Adaptive Pattern recognition and Neural Networks”, Addison-Wesley Publishing Company, 1989.

All of the above 12 documents are incorporated herein by reference.

In addition to previously discussed data communications, Weighted Distance Classifier 906 and NN Logical Engine 908 are in bilateral data communication with Signal I/O Logic 408 for implementing real-time classification of Mechanical Assembly 124.

NN (Neural Network) Parameter Instance 912 is in bilateral data communication with Neural Net Engine 908 for holding interim features (real-time Neural Network Feature Set 934) and neural network data (Real-Time Weighting Matrix 932) during classifier definition. NN Real-Time Parameters 914 provides Weighting Matrix and Adaptation Parameters Instance 928 and Neural Network Feature Set 930 to Neural Net Engine 908 for real-time evaluation of Mechanical Assembly 124. During adaptation to define a new classifier, NN Real-Time Parameters 914 continues to provide real-time classification of Mechanical Assembly 124 even as Neural Network Parameter Instance 912 is used during the definition of a further improved parameter set for use with Neural Net Engine 908. Weighted Distance Real-Time Parameters 916 provides Decision Function Set 924 and Decision Feature Set 926 to Weighted Distance Classifier 906 for real-time evaluation of Mechanical Assembly 124. During adaptation to define a new classifier, Weighted Distance Real-Time Parameters 916 continues to provide real-time classification of Mechanical Assembly 124 even as Weighted Distance Parameter Instance 918 is used during the definition of a further improved parameter set for use with Weighted Distance Classifier 906. Weighted Distance Parameter Instance 918 is in bilateral data communication with Weighted Distance Classifier 906 for holding interim features (Decision Feature Set 922) and Weighted-Distance Classifier data (Decision Function Set 920) during classifier definition.

As previously referenced, Selected Feature Stack 910 stacks the most acceptable features during the process of evaluation; the stacking enables efficient use of memory in retaining the desired features. In this regard, the features of the first-evaluated feature sets are automatically retained in the initial feature set until the stack is full; thereafter, features which demonstrate superior classification performance supplant the lower performing features in the stack.

Stack 910 is appreciated in reference to the reclassification rate (predictive capability and/or error) concept. On the basis of a classified learning sample for which an unambiguous class assignment is performed prior to use for each random sample collected during a learning phase, a measure of appraisal is obtained by reclassifying the learning sample with the respective classification algorithm and a selected subset of classifying data. The ratio of (a) the number of random samples correctly classified in accordance with the given class assignment to (b) the total number of random samples investigated provides (c) a measure of the reclassification rate, error, and predictive capability of the particular evaluated classifier and selected classifying data; as should be appreciated, the goal of the process is ultimately to obtain a very small reclassification error. In the ideal case, (a) the decision on class assignment for reclassification agrees with (b) the class subdivision of the learning sample for all objects on the basis of the maximal alignment of the two membership determinations (i.e., the best feature combination is the one that provides the very best alignment between the first determinations of the human expert and the subsequent determinations of the trained classifier respective to the each of the particular feature combinations tested for that alignment). The advantage of the reclassification error concept is the possibility of determining conclusive values even with a small number of random samples.

Separation sharpness is also a key factor in the example. The classification decision gains unambiguity if the distance between the two largest class memberships increases. Based on these membership values, a sharpness factor is defined; the sharpness factor is considered in the selection process if two or more feature combinations have identical classification rates.

Stack 910 is further appreciated in the context of an overview of certain steps used in the method of feature selection.

In Step 1, the best combinations of features from the totality of all available results are selected (i.e. each feature combination instance is used to train the classifier, classify the sample data of the learning database, generate a comparison between the classified sample and the earlier evaluation of the human expert, and all of the tested feature combination instances thus tested are ranked to define the best predictive feature combinations among all of those combinations evaluated). For this purpose, a sorted list of all calculated measures of quality is prepared; from this list, a specified number of best feature combinations are accepted in a ‘best list’ as a basis for the further selection process.

In step 2, the best feature combinations of Step 1 (in the first iteration, all feature pairs in the stack; in the next iteration, all feature triplets in the stack; in the nth iteration, all combinations of n+1 features) are successively combined with all features not previously included in the pairing of features. Features for which low measures of quality have been calculated in the appraisal of the feature pairs are thus re-included in the selection process.

In step 3, the best feature predictor combination is evaluated against a measure of acceptability, and the process of steps 1 and 2 is repeated until (a) one (best) combination with the desired predetermined number of features has been defined or (b) a specified Recall rate (ability to predict vis a vis the human expert) is achieved.

The following example further shows the nature and operation of Selected Feature Stack 910.

### EXAMPLE 1

Respective to notation, “z” is the Object number for a particular individual having a feature set and membership in a class (i.e. when z is expressed as a numeric value, then F_{z,x} is considered to have a specific quantitative value in the example; when z is expressed as the textual “z”, then F_{z,x} is a logically identified variable representing a classifying feature in the example). An Object, therefore, is a feature vector and affiliated class membership value as a combination.

Beginning with a Feature set size of 2, the example shows Table 3 having 20 samples (10 for class 1 designated with z=1,10, and 10 for class 2 designated with z=11,20) after the set of features has been used to train a classifier and the classifier has been used to categorize each sample in the learning set.

TABLE 3

| | | Membership Value | |
|---|---|---|---|
| | | Predicted from using | |
| | | trained classifier | |
| | | (note: these are examples | Membership |
| | Second | of what the newly-trained | Value Measured |
| First Feature | Feature | classifier defines as a | from Human |
| Value | Value | Membership Value set) | Expert Input |
| F_{1,6} | F_{1,12} | 0 | 0 |
| F_{2,6} | F_{2,12} | 0 | 1 |
| | | | (misclassified) |
| F_{3,6} | F_{3,12} | 0 | 0 |
| F_{4,6} | F_{4,12} | 0 | 0 |
| F_{5,6} | F_{5,12} | 0 | 0 |
| F_{6,6} | F_{6,12} | 0 | 0 |
| F_{7,6} | F_{7,12} | 0 | 0 |
| F_{8,6} | F_{8,12} | 0 | 0 |
| F_{9,6} | F_{9,12} | 0 | 0 |
| F_{10,6} | F_{10,12} | 0 | 0 |
| F_{11,6} | F_{11,12} | 1 | 1 |
| F_{12,6} | F_{12,12} | 1 | 1 |
| F_{13,6} | F_{13,12} | 1 | 1 |
| F_{14,6} | F_{14,12} | 1 | 1 |
| F_{15,6} | F_{15,12} | 1 | 1 |
| F_{16,6} | F_{16,12} | 1 | 1 |
| F_{17,6} | F_{17,12} | 1 | 1 |
| F_{18,6} | F_{18,12} | 1 | 1 |
| F_{19,6} | F_{19,12} | 1 | 1 |
| F_{20,6} | F_{20,12} | 1 | 1 |

As can been seen, the Recall Rate=1.0−1.0/20.0=0.95. For each feature combination of 2 features, a Recall Rate is determined. Table 4 shows the F_{z,6}-F_{z,12} Recall Rate along with another F_{z,6}-F_{z,18} Recall Rate (note that there is no equivalent Table 3 for the F_{z,6}-F_{z,18} Recall Rate determination).

TABLE 4

| | | |
|---|---|---|
| F_{z,6} | F_{z,12} | 95% correct in |
| | | predicting. |
| F_{z,6} | F_{z,18} | 92% correct in |
| | | predicting. |

Table 5 expands on the example of Tables 3 and 4 and adds the Sharpness factor to provide a Sorted list with a stack size of 50.

TABLE 5

| | First | Second | | |
|---|---|---|---|---|
| | feature | feature | Recall | Sharp- |
| Pos. | value | value | Rate | ness |
| 1 | 6 | 12 | 0.95 | 0.151 |
| 2 | 6 | 18 | 0.92 | 0.125 |
| 3 | 7 | 14 | 0.92 | 0.108 |
| 4 | 6 | 21 | 0.91 | 0.132 |
| 5 | 5 | 11 | 0.89 | 0.095 |
| 6 | 4 | 12 | 0.89 | 0.089 |
| 7 | 6 | 19 | 0.88 | 0.086 |
| 8 | 7 | 18 | 0.86 | 0.084 |
| 9 | 5 | 34 | 0.86 | 0.081 |
| 10 | 5 | 33 | 0.85 | 0.082 |
| . | . | . | . | . |
| . | . | . | . | . |
| . | . | . | . | . |
| 48 | 7 | 12 | 0.81 | 0.071 |
| 49 | 7 | 33 | 0.81 | 0.069 |
| 50 | 6 | 19 | 0.80 | 0.068 |

Continuing the Example, Table 6 shows a new incoming evaluation:

TABLE 6

| First | Second | | |
|---|---|---|---|
| feature | feature | Recall | Sharp- |
| value | value | Rate | ness |
| 8 | 14 | 0.90 | 0.116 |

This new F_{z,8}-F_{z,14} result of Table 6 pushes part of the Stack 910 down as shown in Table 7 to provide an updated list after evaluation of feature combination 8|14.

TABLE 7

| | Feature | Feature | Recall | |
|---|---|---|---|---|
| Pos. | Value 1 | Value 2 | Rate | Sharpness |
| 1 | 6 | 12 | 0.95 | 0.151 |
| 2 | 6 | 18 | 0.92 | 0.125 |
| 3 | 7 | 14 | 0.92 | 0.108 |
| 4 | 6 | 21 | 0.91 | 0.132 |
| 5 | 8 | 14 | 0.90 | 0.116 |
| 6 | 5 | 11 | 0.89 | 0.095 |
| 7 | 4 | 12 | 0.89 | 0.089 |
| 8 | 6 | 19 | 0.88 | 0.086 |
| 9 | 7 | 18 | 0.86 | 0.084 |
| 10 | 5 | 34 | 0.86 | 0.081 |
| . | . | . | . | . |
| . | . | . | . | . |
| . | . | . | . | . |
| 48 | 6 | 17 | 0.82 | 0.081 |
| 49 | 7 | 12 | 0.81 | 0.071 |
| 50 | 7 | 33 | 0.81 | 0.069 |

End of Example 1

FIG. 10 presents detail in a decision function set of the pattern recognition logic. Decision Function Detail 1000 shows detail in Decision Function Set 920 and Decision Function Set 924. Each Class used to characterize a measured signal (whether used in classifier definition or in real-time classification) has an affiliated eigenvalue set and eigenvector set. In a system of N Classes being used for classification, Class 1 Eignenvector Set 1002, Class N Eigenvector Set 1004, Class 1 Eigenvalue Set 1006, and Class N Eigenvalue Set 1008 are each retained as shown within Decision Function Set 920 and (for the real-time case) in Decision Feature Set 926.

FIG. 11 presents a block flow diagram of the signal and data I/O and logging logic in the monitoring system. Signal Logic Detail 1100 therefore presents detail in Signal I/O Logic 408. Pattern Recognition Logic 406, Reference Data Logic 404, Real-Time Executive Logic 402, Signal Conditioning Logic 410, and Human Interface Logic 412 are reprised from FIG. 4. Feature Derivation Engine 1102 derives features from input signals Analog Input Signal 118 and/or Digital Input Signal 116 in the context of attributes of Tool-Specific Feature Functions 1104 (discussed in further detail in Derivation Functions 1200 of FIG. 12). Feature Derivation Engine 1102 is in bilateral data communication with Real-Time Signal Input Engine 1108 in achieving several key functionalities: (1) data reading communication of measurements respective to Analog Input Signal 118 and Digital Input Signal 116, (2) acquiring data from Reference Data Logic 404, (3) occasionally acquiring updated Tool-Specific Feature Functions 1104 routines from Human Interface Logic 412, and (4) data writing communication of derived features and feature values to Real-Time Signal Input Engine 1108 for further communication to Pattern Recognition Logic 406. Log of Learning Measurements 1106 is in data writing communication with Real-Time Signal Input Engine 1108 for receiving and holding measurements respective to anomalous measured vectors when Real-Time Signal Input Engine 1108 is prompted by Rework Engine 810. Log of Learning Measurements 1106 also is in bilateral data communication with Human Interface Logic 412 and Network Interface 1116 for further communication or copying of Log of Learning Measurements 1106 data to an operating technician, a floppy, a CD-ROM, or other system. Real-Time Signal Input Engine 1108 is in bilateral data communication with Human Interface Logic 412 for sending classification results and for receiving updated Tool-Specific Feature Functions 1104 routines, for receiving configuration data for hardware signals (for storage in Signal Configuration Schema 1110), and for receiving a flag respective to an anomalous measured vector. Real-Time Signal Input Engine 1108 is in bilateral data communication with Feature Derivation Engine 1102 as previously described. Real-Time Signal Input Engine 1108 is in bilateral data communication with Pattern Recognition Logic 406 for sending derived feature values and feature data to Pattern Recognition Logic 406 and for receiving classification feedback respective to feature values and feature data. Real-Time Signal Input Engine 1108 is in bilateral data communication with Reference Data Logic 404 for informing Reference Data Logic 404 of the particular signal being read and responsively acquiring feature data to classify the signal. Real-Time Signal Input Engine 1108 is in bilateral data communication with Real-Time Executive Logic 402 for (a) receiving execution enablement data signals, multi-process and/or multitasking interrupts, and (b) sending feedback and flagging inputs so that responsive logic is executed in a unified and coordinated real-time cadence. Real-Time Signal Input Engine 1108 is in bilateral data communication with Network Interface 1116 for receiving certain measured signal data directly from Network 146 and for interacting with certain external systems via Network 146 as needed. Real-Time Signal Input Engine 1108 is in bilateral data communication with Process Information System Interface 1112 for interfacing with Process Information System 104; in Signal Logic Detail 1100 of FIG. 11, Process Information System Interface 1112 is shown using Network Interface 1116 to interface to Process Information System 104, but the interface can also be via another data communication means such as a direct serial link. PI Buffer 1114 is used for holding data exchanged between Process Information System 104 and Classification Computer System 110 during transfers.

FIG. 12 presents detail in tool-specific feature derivation functions. Derivation Functions 1200 shows further detail in the particular functions used to derive features used in classification of Mechanical Assembly 124. Each Feature Function contains the logical routine used to derive the features. For any particular signal, as indicated in the discussion of Reference Data Detail 1300 in FIG. 13, a function (Aligned Function 1326) and set of attributes (Related Functional Attribute 1328) is defined for at least one feature; this data is referenced by Feature Derivation Engine 1102 and which applies the appropriate function in Tool-Specific Feature Functions 1104 to derive the feature values for use in Pattern Recognition Logic 406.

FFT Feature Function 1202 is generally understood in the art. This function is described in (1) Brigham, E. O., “The Fast Fourier Transform”, Prentice-Hall Inc., 1974 and also in (2) Cooley, J. W. and Tukey, J. W., “An Algorithm for the Machine Calculation of Complex Fourier Series”, Mathematical Computation 19, 1965—which are both incorporated herein by reference.

RPM Feature Function 1204, Minimum Signal Value Feature Function 1206, Maximum Signal Value Feature Function 1208, and RMS Feature Function 1210 are generally understood in the art. These functions are described in

Bannister, R. H., “A review of rolling element bearing monotoring techniques”, Fluid Machinery Committee, Power Industries, London, June 1985;

Callacott, R. A., “Mechanical Fault Diagnosis and condition Monitoring”, Chapman and Hall, London, 1977;

Hunt, T. M, “Condition Monitoring of Mechanical Equipment and Hydraulic plant”, Chapman and Hall, 1996;

Rao, B. K. N., “Handbook of condition monitoring”, Elsevier Advanced Technologies, 1996;

Harris, T. A., “Rolling Element bearing Analysis”, Third Edition, New York, 1991, John Wiley & Sons, Inc.;

Berry, J. E., “How to Track Rolling Element Bearing Health with Vibration Signature Analysis”, Sound and Vibration, 25 (1991) 11, pp. 24-35;

Dyer, D. and Stewart, R. M., “Detection of Rolling Element Bearing Damage by Statistical Vibration Analysis”, Journal of Mechanical Design, Vol. 100, 1978, pp. 229-235.; and

Edgar, G. R. and Gore, D. A., “Techniques for the Early Detection of Rolling Bearing Failures”, SAE Technical Paper Series, 1984, pp. 1-8.

All of these 8 documents are incorporated herein by reference.

Curtosis Feature Function 1212 is generally understood in the art. This function is described in Rush, A. A., “Kurtosis a crystal ball for maintenance engineers”, Iron and Steel International, 52, 1979, S. 23-27, which is incorporated herein by reference. Filtered Curtosis Feature Function 1214 is achieved by time-filtering a Curtosis value.

Envelope Set Feature Function 1216 is generally understood in the art. This function is described in Jones, R. M., “Enveloping for bearing Analysis”, Sound and Vibration, 30 (2) 1996, page 10 which is incorporated herein by reference.

Cepstrum Feature Function 1218 is generally understood in the art. This function is described in Randall, R. B., “Cepstrum Analysis and Gearbox Fault Diagnosis”, Brüel and Kjaer application note No. 233 which is hereby incorporated herein by reference.

CREST Feature Function 1220 is generally understood in the art. This function is described in Bannister, R. H., “A review of rolling element bearing monitoring techniques”, Fluid Machinery Committee, Power Industries, London, June 1985 which is incorporated herein by reference.

Filtered CREST Feature Function 1222 is generally understood in the art. This function is described in (1) Dyer, D. and Stewart, R. M., “Detection of Rolling Element Bearing Damage by Statistical Vibration Analysis”, Journal of Mechanical Design, Vol. 100, 1978, pp. 229-235; and (2) Bannister, R. H., “A review of rolling element bearing monitoring techniques”, Fluid Machinery Committee, Power Industries, London, June 1985. Both of these publications are hereby incorporated herein by reference.

Dimensionless Peak Amplitude Feature Function 1224 is derived from a time signal as a dimensionless parameter. The mean peak height of the time signal characterizes the degree of peak plurality and peak impulse magnitude, and the periodicity and constancy between a peak and two following peaks. To derive the dimensionless parameter of Dimensionless Peak Amplitude Feature Function 1224, the ratio between the mean amplitude and the signal “base” is first established.

Equation 1

Base level:

$${a}_{b} = \frac{1}{M} {\sum }_{j = 1}^{M} abs ( {x}_{j} ) with M samples of the time signal$$

M=Number of data points

x=digital data samples

Equation 2

Average peak amplitude

$${a}_{MP} = \frac{1}{N} {\sum }_{j = 1}^{N} {a}_{Pj}$$

N=Number of detected peaks in time signal

aₚⱼ=Amplitude of peak j

The Feature of Dimensionless Peak Amplitude Feature Function 1224 is then

Equation 3

$${f}_{1} = \frac{{a}_{MP}}{{a}_{b}}$$

Dimensionless Peak Separation Feature Function 1226 is derived from a time signal as a dimensionless parameter. An ideal roller bearing damage consistently generates peaks in the time signal from the sensor monitoring the bearing. The constancy of generated peaks (as related to the distances between the peaks) is expressed by calculating all distances between a set of peaks and building the variance to a mean value. A roller bearing in good condition reflects a high degree of variance through small, stochastically distributed signal peaks. To ensure the comparability of different rotation speeds, a dimensionless ratio is established by dividing the variance by the mean distance between peaks.

Equation 4

Average peak distance

$${d}_{MP} = \frac{1}{N - 1} {\sum }_{j = 1}^{N - 1} {d}_{Pj}$$

N=Number of detected peaks in time signal

dₚⱼ=Distance between peak j and peak j-1

Equation 5

$${σ}_{P} = \frac{1}{N - 2} \sqrt{{\sum }_{j = 1}^{N - 1} {( {d}_{pj} - {d}_{MP} )}^{2}}$$

The feature of Dimensionless Peak Separation Feature Function 1226 is then calculated from

Equation 6

$${f}_{2} = \frac{{d}_{MP}}{{σ}_{P}}$$

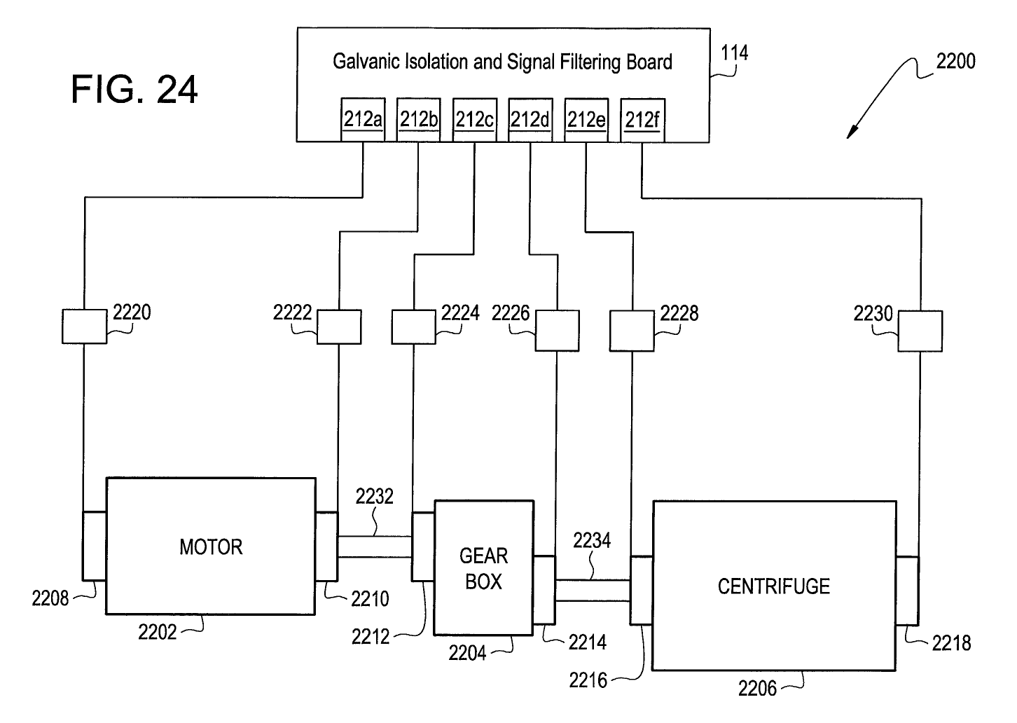

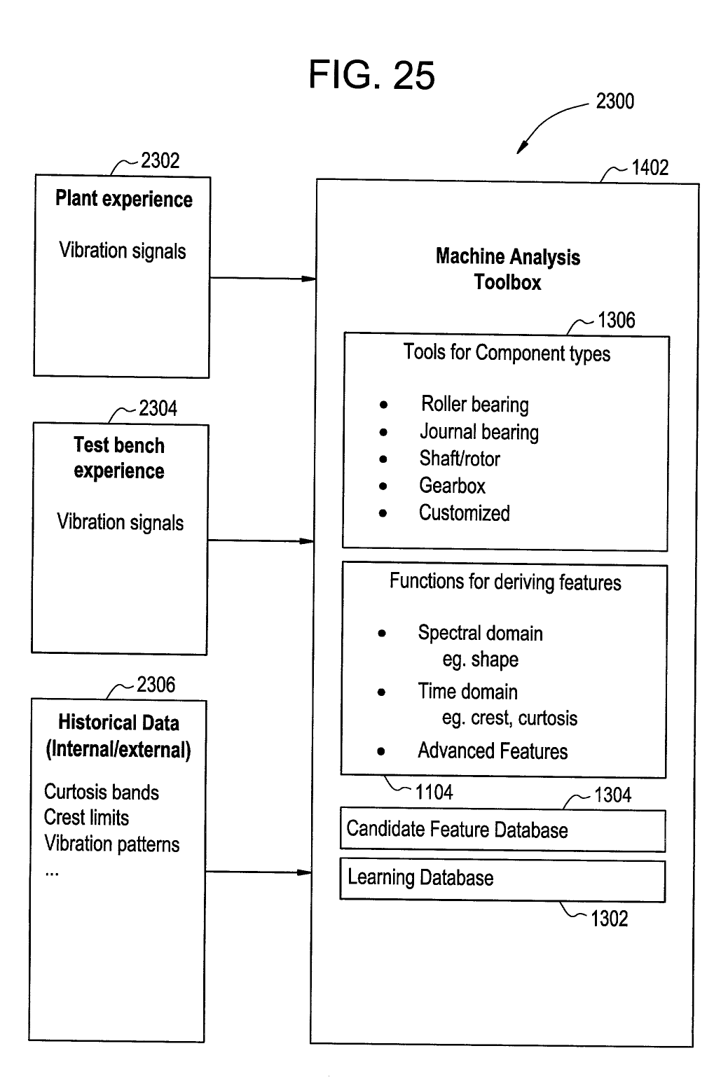

FIG. 13 presents a block flow diagram of the reference data logic in the monitoring system. Reference Data Detail 1300 shows detail in Reference Data Logic 404. Pattern Recognition Logic 406, Signal I/O Logic 408, Real-Time Executive Logic 402, and Human Interface Logic 412 are reprised from FIG. 4. For any particular signal, as indicated in the discussion of FIG. 12, a function (Aligned Function 1326) and set of attributes (Related Functional Attribute 1328) is defined for at least one feature; this data is referenced by Feature Derivation Engine 1102, which applies the appropriate function in Tool-Specific Feature Functions 1104 to derive feature values for use in Pattern Recognition Logic 406. Learning Database 1302 shows a set of records related to a particular Tool ID 1334. For each Tool ID 1334 there is a set of features, Feature 1 (F1) 1318 through Feature N (Fn) 1320 for which a judgment (from a human expert) is also expressed as a value in Judgment Value 1322 data-field. A set of rows of values showing Feature 1 1318 through Feature N 1320 values and a judgment as a class of operational status is provided for each Tool ID 1334. In the context of the aligning provided by the design of Candidate Feature Database 1304 and Tools Database 1306 and Component Database 1308, Learning Database 1302 therefore represents the collected input of human professional understanding (respective to interpretation of the status of Mechanical Assembly 124 in operation) to Classification Computer System 110 so that Classification Computer System 110 provides rapid mechanized access in real-time to that collected understanding. A further discussion of how Feature N 1320 data is assembled is described in the discussion respective to Toolbox Development Overview 2300 in FIG. 25. Further considerations in (1) selecting a proper number of classes (providing an inherent class structure) for articulating judgment and (2) defining acceptable predictability of a classifier instance is discussed in Component Assembly 2200 and Toolbox Development Overview 2300 of FIGS. 24 and 25. Candidate Feature Database 1304 is a table of a set of Features 1324 and a Related Tool Identifier 1330 data-field showing the particular Tool ID 1334 set for which that Feature 1324 is relevant. In this regard, a particular Feature 1324 is any one feature in the set of features (Feature 1 1318 through Feature N 1320) in Learning Database 1302 where one Feature N 1320 record is related to one Tool ID 1334. Aligned Function 1326 logical identifier is also provided along with Related Functional Attribute 1328 so that Feature Derivation Engine 1102 executes the proper function of Tool-Specific Feature Functions 1104 and also determines the appropriate attribute of the derived function in derivation of a particular feature value. Tools Database 1306 is a table of values respective to the variable types Input Channel Logical ID 1332, Tool ID 1334, and Tool Identifying Term 1336 (for facilitating human interaction with Reference Data Detail 1300 by providing a lexical string identifier for display on Monitor 102). Input Channel Logical ID 1332 is dependent upon a particular Filter Circuit 300 on Band-Pass-Filter Circuitry Board 204; the purpose of Input Channel Logical ID 1332 is to enable crosscheck in execution of Hardware Configuration Function 702 so that an operating technician attaches an instance of Analog Input Signal 118 to the proper Signal Wire Terminators 212. Component Database 1308 provides a further reference so that instances of Component Identifier 1338 (see the further discussion of Component Assembly 2200 in FIG. 24) are, when combined with a particular Sensor Type 1340, wired to the proper Input Channel Logical ID Field 1342. Note that, in using Component Database 1308 and Tools Database 1306, a Component Identifier 1338 in combination with a Sensor Type 1340 “points” to acceptable Input Channel Logical ID Field 1342 values. The Input Channel Logical ID Field 1342 values (which could be more than one relative Signal Wire Terminator 212), when mapped to the table of Tools Database 1306, enable identification of a particular Input Channel Logical ID 1332; ID 1332 then identifies an appropriate Tool ID 1334 in alignment with Component Identifier 1338, Sensor Type 1340, and Input Channel Logical ID 1332 (resolving hardware alignment considerations in the classifier). Tool ID 1334 then references a set of Feature 1324 instances in Candidate Feature Database 1304 (a datalogical reference for evaluation of Component Identifier 1338 in operation) and also references a particular record of Learning Database 1302 (collected human learning in intersection with the set of Feature 1324 instances in the datalogical reference frame of Candidate Feature Database 1304). The set of Features 1324 with their particular Learning Database 1302 instance is then used in conjunction with (a) Progressive Feature Selector 904 (or, alternatively, Evolutionary Feature Selector 902) and (b) with Weighted Distance Classifier 906 (or, alternatively, Neural Net Engine 908) to derive a subset, for each Judgment Value 1322 class, of (c) Feature 1 1318-Feature N 1320 features for use in real-time classification. Real-Time Signal Feature Set Instance 1310 is the subset, for each Judgment Value 1322 class, of (c) Feature 1 1318-Feature N 1320 features for use in real-time classification for a particular Analog Input Signal 118 (Digital Input Signal 116 or Analog Input Signal 118/Digital Input Signal 116 combination) instance respective to at least one identified judgment class (Judgment Value 1322 type). Real-Time Signal Feature Set Instance 1310 points to a particular Decision Function Set 924 instance and aligns with a respective Decision Feature Set 926. Real-Time Signal Feature Set Instance 1310 is accessed by Signal I/O Logic 408 in interactions with Feature Derivation Engine 1102 and Pattern Recognition Logic 406. Feature Data Evaluation Engine 1312 (in data reading communication with Learning Database 1302, Candidate Feature Database 1304, Tools Database 1306, and Component Database 1308) is used with Feature Selection Function 714 and Classifier Definition Function 718 in defining a classifier instance. Configuration Tables Interface 1314 is in bilateral data communication with Learning Database 1302, Candidate Feature Database 1304, Tools Database 1306, Component Database 1308, and Real-Time Signal Feature Set Instance 1310 for loading these tables and providing the operating technician with a full reference frame for evaluating the status of the data which is custom to a particular instance of Mechanical Assembly 124 (note that Configuration Tables Interface 1314 is in bilateral data communication with Human Interface Logic 412 and Real-Time Executive Logic 402). Threshold Value 1316 is used by Feature Data Evaluation Engine 1312 in a decision to use Evolutionary Feature Selector 902 in preference to Weighted Distance Classifier 906. Depending on the capability of the particular Classification Computer CPU 138 and affiliated computing resources, the use of Evolutionary Feature Selector 902 is preferable for feature sets above Threshold Value 1316.

FIG. 14 presents details for a machine analysis toolbox. Toolbox 1400 shows Machine Analysis Toolbox 1402. In this regard, in one embodiment, a data schema section is provided with Learning Database 1302, Candidate Feature Database 1304, Tools Database 1306, and Tool-Specific Feature Functions 1104 as an aligned set with a unifying logical identified data value in Data Feature Tool Object 1404. Machine Analysis Toolbox 1402 is, in one embodiment, unified in one data schema logical section, or, in the embodiment shown in Signal Logic Detail 1100 and Reference Data Detail 1300, virtually provided in more than one logical section. Attributes A1 and A3 shown in column 1328 (FIG. 13) are the feature attributes of the signal vector as derived from feature function 1326 to become classification feature 1324 (as noted earlier, Features frequently reference a variable possessing a joining consideration or datalogical nexus between, first, an attribute derived in the context of a function from the measured signal and, second, a variable used in a classifier). Machine Analysis Toolbox 1402 is, in one embodiment, resident as a logical object set in data form on a unified physical storage device such as a CD-ROM, a “floppy”, or other like media. In this regard, (1) hardware alignment considerations, (2) the datalogical reference for evaluation of components in operation, (3) the related collected human learning in intersection with the datalogical reference frame, and (4) the functions needed to derive the data needed for the datalogical reference frame all continuously improve with time; these elements in the embodiment are beneficially upgraded periodically in Classification Computer System 110 in a unified manner to provide access to improved methodology. Machine Analysis Toolbox 1402, therefore, is manifested virtually in all embodiments and is manifested in unified logical form in some embodiments and in separated logical form in other embodiments.

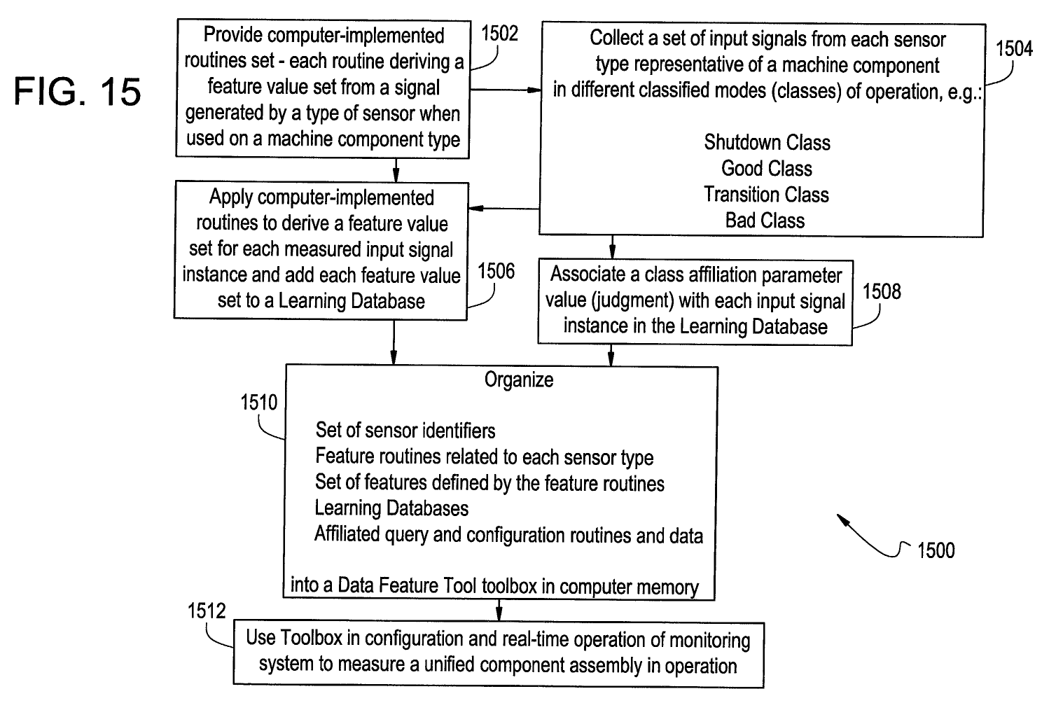

FIG. 15 presents an overview flowchart of the organization of key information in constructing and using the preferred embodiments. Use Process Overview 1500 outlines a broad process perspective in use of the classifier. In Setup Step 1502, a computer-implemented routines set is provided, with each routine deriving a feature value set from a signal generated by a type of sensor when used on a machine component type. In Testing Step 1504, a set of input signals is collected from each sensor type representative of a machine component in different classified modes (classes) of operation (e.g., without limitation, a Shutdown Class, a Good Class, a Transition Class, and a Bad Class). In Feature Definition Step 1506, the computer-implemented routines are applied to derive a feature value set for each measured input signal instance, and each feature value set is added to a Learning Database. In Expert Input Step 1508, a class affiliation parameter value (judgment) is associated with each input signal instance in the Learning Database. In this regard, the “classified modes” of operation of Testing Step 1504 are based on human understanding; in Expert Input Step 1508, this understanding is datalogically expressed and affiliated with each signal for which a feature value set was derived in Feature Definition Step 1506. In Toolbox Assembly Step 1510, the information of Testing Step 1504, Feature Definition Step 1506, and Expert Input Step 1508 is organized in the context of the data reference of the routines of Setup Step 1502. In this regard, the (a) set of sensor identifiers, (b) feature routines related to each sensor type, (c) sets of features defined by the feature routines, (d) learning databases, and (e) affiliated query and configuration routines and data are all collected into a Toolbox Of Data Feature Tools 1402 for use in computer memory. In Use Step 1512, the Toolbox 1402 is used in configuration and real-time operation of the monitoring system to measure the status of a unified component assembly (Mechanical Assembly 124) in operation.

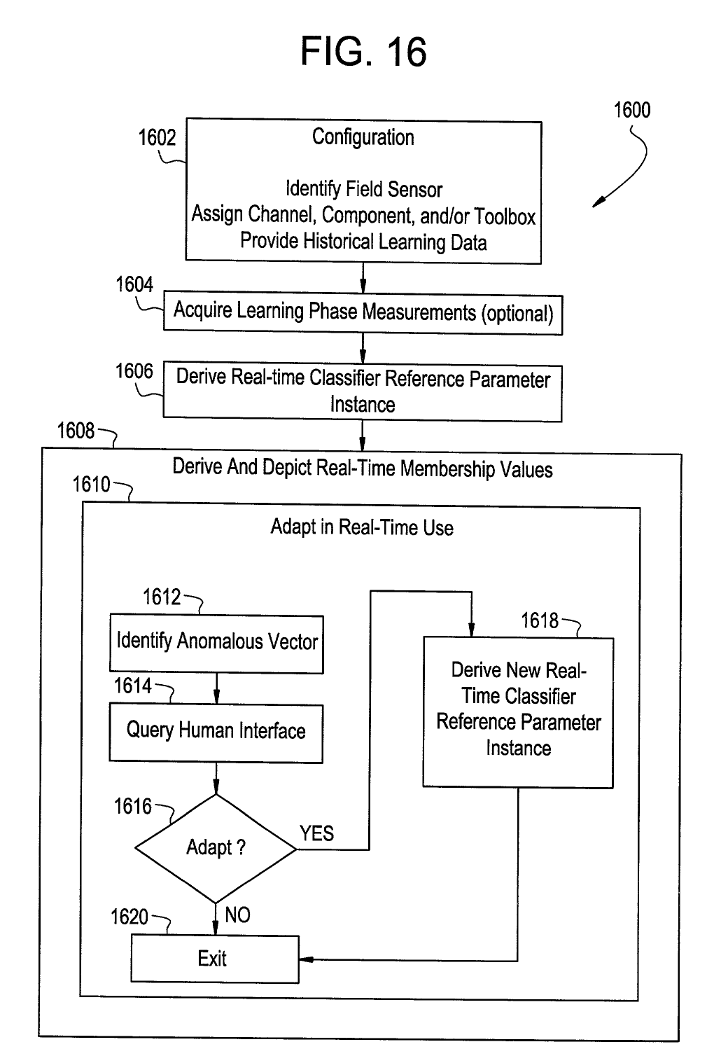

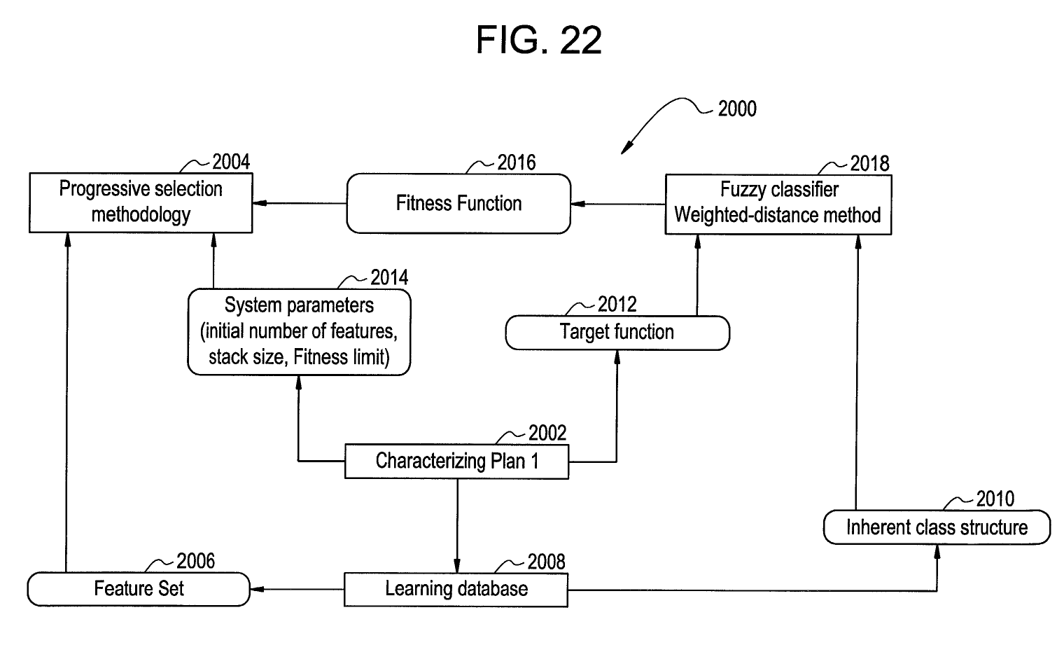

FIG. 16 presents a flowchart of key classification steps. Implementation Process Overview 1600 shows further detail in Use Step 1512. In Configuration Step 1602, configuration of Reference Data Logic 404 customizes Classification Computer System 110 to a particular instance of Mechanical Assembly 124 by (a) identifying deployed sensors (see Component Assembly 2200 of FIG. 22); (b) assigning a channel (Signal Wire Terminators 212), component/sensor (Component Identifier 1338 & Sensor Type 1340), and/or Toolbox Tool ID (Related Tool Identifier 1330) to each sensor; and (c) providing historical learning data to Learning Database 1302.

In Optional Learning Step 1604, an optional learning phase is implemented to acquire further measurements in the learning base. This is an optional step in the sense that such learning is alternatively acquired in the course of adaptation (Adaptation Step 1610); however, in certain applications, it is beneficial to perform system testing prior to full commitment to use so that Learning Database 1302 reflects both (a) measurements and judgments for the type of component and sensor in prior use on other embodiments of Mechanical Assembly 124 or from a test environment and (b) specifically judged measurements for the particular Mechanical Assembly 124 being monitored by the instance of Classification Computer System 110 configured.

In Classifier Derivation Step 1606, a real-time classifier reference parameter instance (Weighted Distance Real-Time Parameters 916 or NN Real-Time Parameters 914) is derived for each component and sensor combination. In Real-Time Classifying Step 1608, derivation and depiction of real-time membership values (the membership of each component in each class valid for that component) is performed in an ongoing manner. In Adaptation Step 1610, adaptation of Learning Database 1302 and redefinition of Weighted Distance Real-Time Parameters 916 (or NN Real-Time Parameters 914) is executed (via multi-process and/or multitasking interrupts and execution enablement data signals from Executive Logic 402) along with on-going derivation and depiction of real-time membership values. In Anomalous Vector ID Step 1612, anomalous vectors are identified (Rework Engine 810). In Human Query Step 1614, Monitor 102 is queried for operating technician input respective to judgment for the anomalous vector. In Adaptation Decision 1616, the operating technician inputs a decision to proceed to redefine Weighted Distance Real-Time Parameters 916 (or NN Real-Time Parameters 914). If the decision result is NO, Adaptation Decision 1616 terminates to Exit Step 1620. If the decision result is YES, Adaptation Decision 1616 terminates to Replacement Classifier Derivation Step 1618. In Replacement Classifier Derivation Step 1618, a new real-time classifier reference parameter instance is determined via coordination of Adaptation Function 722 in Control Block 604. Weighted Distance Parameter Instance 916 (or Neural Network Parameter Instance 912) provide storage for the redefinition of Weighted Distance Real-Time Parameters 916 (NN Real-Time Parameters 914) so that the existing instances of Weighted Distance Real-Time Parameters 916 (NN Real-Time Parameters 914) are used for real-time classification of Mechanical Assembly 124 during the adaptation process. In the final portion of Replacement Classifier Derivation Step 1618, the new version of Weighted Distance Parameter Instance 916 (NN Parameter Instance 912) replaces the old version for the particular signal for which the adaptation is being executed. In Exit Step 1620, the adaptation process concludes with an exit.

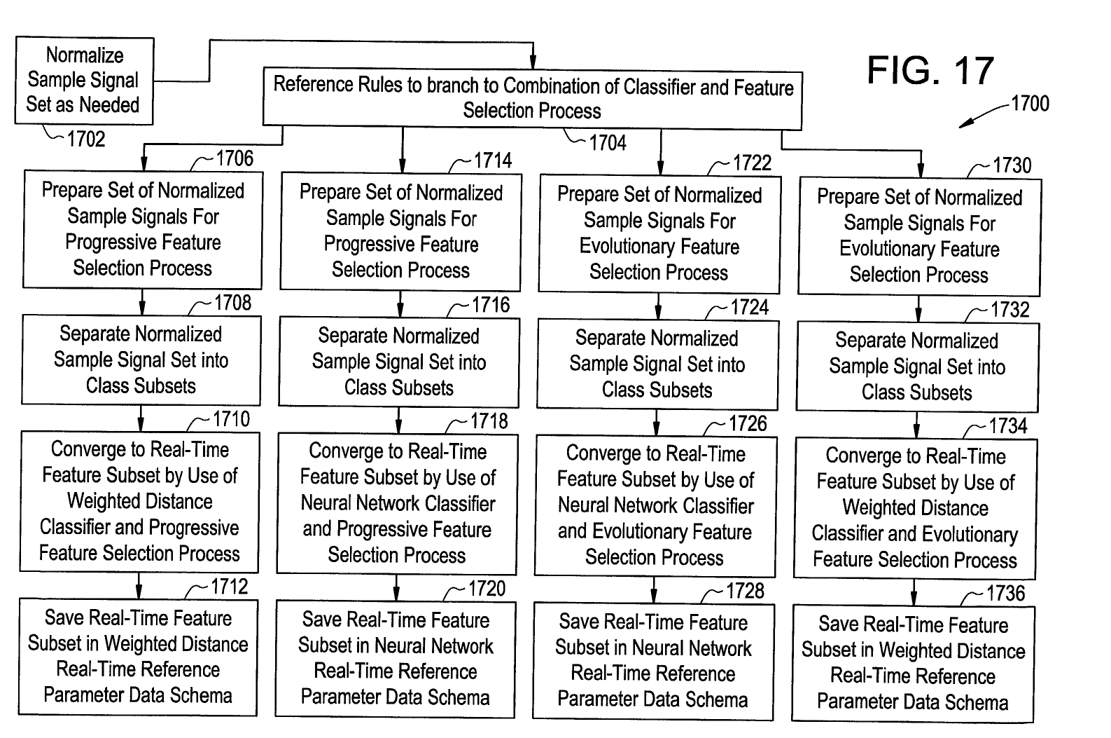

FIG. 17 presents a flowchart detailing decisions in use of progressive feature selection, evolutionary feature selection, neural network classification, and weighted distance classification. Classification Overview 1700 further defines Classifier Derivation Step 1606 to show the process by which each measurement vector (derived from Analog Input Signal 118, Digital Input Signal 116, or a combination of Digital Input Signal 116 and Analog Input Signal 118 signals) is classified. In Sample Signal Preparation Step 1702, the signal sample values are normalized for use in classification. This step is not executed in every contemplated embodiment, but is generally a preferable approach. In this regard, “normalized sample signals” reference the normalized features as a whole for a particular set of learning samples taken collectively and resident for a particular Tool ID 1334 in Learning Database 1302. In Branch Step 1704, reference rules branch the method to a particular combination of (a) classifier and (b) feature selection process. This branching is further described respective to considerations outlined in Table 8.

TABLE 8

| | | Evolutionary | Weighted | |
|---|---|---|---|---|
| | | Feature | Distance | Progressive |
| Situation | NN | Selection | Classifier | Feature Selection |
| Problems with a | X | X | X | X |
| small number of | | | | |
| possible input | | | | |
| features (<400) | | | | |
| Problems with a | X | X | X | |
| large number of | | | | |
| possible input | | | | |
| features (>400) | | | | |
| Learning data set | X | X | | X |
| has more then one | | | | |
| disjunct cluster | | | | |
| with equal class | | | | |
| membership | | | | |
| Strong ellipsoidal | | X | X | X |
| distribution for the | | | | |
| data set | | | | |
| High level of | | | X | X |
| deterministic | | | | |
| solutions (safety | | | | |
| relevance issues, | | | | |
| minimum of | | | | |
| control parameters) | | | | |

In PF-WD Preparation Step 1706, a set of normalized sample signals is prepared for the progressive feature selection process. In PF-WD Class Separation Step 1708, the normalized sample signal set is separated into class subsets. In PF-WD Feature Set Definition Step 1710, the weighted distance classifier and the progressive feature selection process converge Learning Database 1302 data for the particular sample signals to a real-time feature subset. In PF-WD Real-Time Set Storage Step 1712, the real-time feature subset is saved in Weighted Distance Real-Time Parameters 916.

In PF-NN Preparation Step 1714, a set of normalized sample signals is prepared for the progressive feature selection process. In PF-NN Class Separation Step 1716, the normalized sample signal set is separated into class subsets. In PF-NN Feature Set Definition Step 1718, the neural network classifier and the progressive feature selection process converge Learning Database 1302 data for the particular sample signals to a real-time feature subset. In PF-NN Real-Time Set Storage Step 1720, the real-time feature subset is saved in NN Real-Time Parameters 914.

In EF-NN Preparation Step 1722, a set of normalized sample signals is prepared for the evolutionary feature selection process. In EF-NN Class Separation Step 1724, the normalized sample signal set is separated into class subsets. In EF-NN Feature Set Definition Step 1726, the neural network classifier and the evolutionary feature selection process converge Learning Database 1302 data for the particular sample signals to a real-time feature subset. In EF-NN Real-Time Set Storage Step 1728, the real-time feature subset is saved in NN Real-Time Parameters 914.

In EF-WD Preparation Step 1730, a set of normalized sample signals is prepared for the evolutionary feature selection process. In EF-WD Class Separation Step 1732, the normalized sample signal set is separated into class subsets. In EF-WD Feature Set Definition Step 1734, the weighted distance classifier and evolutionary feature selection process converge Learning Database 1302 data for the particular sample signals to a real-time feature subset. In EF-WD Real-Time Set Storage Step 1736, the real-time feature subset is saved in Weighted Distance Real-Time Parameters 916.

FIG. 18 presents detail in the weighted distance method of classifying and progressive feature selection. Progressive Feature Selection Process 1800 provides an overview of the method executed by Progressive Feature Selector 904. The set of features Feature 1 1318 to Feature N 1320 for a particular Tool Identifying Term 1336 is processed to define the best subset for use in real-time classification. In this regard, the size of the subset is dependent upon the particular Classification Computer CPU 138 and affiliated resources, the frequency at which real-time membership determinations are desired, the instances of Tool Identifying Term 1336 in Classification Computer System 110, and like considerations. In Weighted-Distance Classifier Initial Features Step 1802, the features are individually evaluated if more than 400 features are defined for a particular signal. If less than 400 features are defined, each feature couplet is evaluated. In Weighted-Distance Classifier Initial Feature Ranking Step 1804, fitness for a classifier respective to each feature or feature couplet is evaluated. In Weighted-Distance Classifier Feature Selecting Step 1806, the best performing features or feature couplets are selected to Selected Feature Stack 910. On subsequent iterations, the best feature sets are selected to Selected Feature Stack 910. In Weighted-Distance Classifier Feature Set Augmentation Step 1808, the feature sets in the stack are separately augmented with each individual feature not in the set. In Weighted-Distance Classifier Feature Set Fitness Decision 1810, each new feature set is evaluated for classification prediction fitness. If sufficient fitness prediction is not achieved by any feature set (“NO” decision result), then the process returns to Weighted-Distance Classifier Feature Selecting Step 1806. If the decision result is YES, Weighted-Distance Classifier Feature Set Fitness Decision 1810 terminates to WD Feature Set Acceptance Step 1812. In Weighted-Distance Classifier Feature Set Acceptance Step 1812, the feature set achieving the best fitness is written into Weighted Distance Real-Time Parameters 916 (NN Real-Time Parameters 914). FIG. 19 shows further detail in Steps 1804, 1806, and 1808 in feature evaluation detail 2900. An example of the above process follows.

### EXAMPLE 2

Control parameters for the selection strategy are similar to Example 1 used to describe Stack 910 in the discussion of FIG. 9. First, in reference (1) to the reclassification rate (predictive capability and/or error) concept and (2) to the basis of a classified learning sample for which an unambiguous class assignment is performed prior to use for each random sample collected during a learning phase, a measure of appraisal is obtained by reclassifying the learning sample with the respective classification algorithm and a selected subset of classifying data. The ratio of (a) the number of random samples correctly classified in accordance with the given class assignment to (b) the total number of random samples investigated provides a measure of the reclassification rate, error, and predictive capability of the particular evaluated classifier and selected classifying data; as should be appreciated, the goal of the process is ultimately to obtain a very small reclassification error. In the ideal case, the decision on class assignment for reclassification agrees with the class subdivision of the learning sample for all objects on the basis of the maximal membership. The advantage of the reclassification error concept is the possibility of determining conclusive values even with a small number of random samples.

Separation sharpness is also a key factor in the example. The classification decision gains unambiguity if the distance between the two largest class memberships increases. Based on these membership values a sharpness factor is defined, which is considered in the selection process if two or more feature combinations have identical classification rates.

Respective to notation, “z” is the Object number for a particular individual having a feature set and membership in a class (i.e. when z is expressed as a numeric value, then F_{z,x} is considered to have a specific quantitative value in the example; when z is expressed as the textual “z”, then F_{z,x} is a logically identified variable representing a classifying feature in the example). An Object, therefore, is a feature vector and affiliated class membership value as a combination.

In this example, the feature “gene pool” has a Maximum Set Size of F_{z,1} . . . F_{z,10} and the progressive search algorithm determines a sub-optimal feature subset containing 3 features.

Human expert membership value “0” indicates that the sample belongs to class A, and a value “1” indicates that the sample belongs to class B. The human expert's decision is available for all samples of the learning data base (in this example, a sample size of 20).

In Step 1 of the example, all samples from the learning database are read into the progressive selection method.

In Step 2 of the example, the search algorithm starts with an opening minimum set of 2 features F_{z,x}-F_{z,y} for each individual (see notational paragraph above respective to variable “z”). All possible combinations of two features are then defined. Table 9 shows all combinations of 2 features containing Feature “1” and the possible feature pairs. The combination F_{z,1} and F_{z,2} is defined using the notational form “1|2”.

TABLE 9

| | | |
|---|---|---|
| 1 \| 2 | F_{z,1} | F_{z,2} |
| 1 \| 3 | F_{z,1} | F_{z,3} |
| 1 \| 4 | F_{z,1} | F_{z,4} |
| 1 \| 5 | F_{z,1} | F_{z,5} |
| 1 \| 6 | F_{z,1} | F_{z,6} |
| 1 \| 7 | F_{z,1} | F_{z,7} |
| 1 \| 8 | F_{z,1} | F_{z,8} |
| 1 \| 9 | F_{z,1} | F_{z,9} |
| 1 \| 10 | F_{z,1} | F_{z,10} |

In Table 10 all possible combinations of any two features are listed.

TABLE 10

1. 1 | ( 2, 3, 4, 5, 6, 7, 8, 9, 10)
2. .2 | ( 3, 4, 5, 6, 7, 8, 9, 10)
3. 3 | ( 4, 5, 6, 7, 8, 9, 10)
4. 4 | ( 5, 6, 7, 8, 9, 10)
5. 5 | ( 6, 7, 8, 9, 10)
6. 6 | ( 7, 8, 9, 10)
7. 7 | ( 8, 9, 10)
8. 8 | ( 9, 10)
9. 9 | (10)

The performance of each feature combination is determined by (1) training the Weighted Distance Classifier, (2) calculating the classification results for all samples of the learning data set, and (3) comparing the results of the calculation with the initial human expert determination (i.e., establishing the comparison of respective ability of the trained classifier to return, respective to a particular “trial” feature combination, the same determination of membership as the human expert for a particular measurement).

Table 11 demonstrates this process for the feature combination 6|10 after the performance of each feature combination has been determined.

TABLE 11
Classification results for the whole learning data set.

| | | | | Class | |
|---|---|---|---|---|---|
| | | | | Member- | |
| | | | | ship | |
| | | Membership | Membership | Value | |
| | | value for | value for | calculated | Membership |
| | | class 1 | class 2 | from both | Value |
| | | predicted | predicted | class | Measured |
| First | Second | from using | from using | member- | from Human |
| Feature | Feature | trained | trained | ship | Expert |
| Value | Value | classifier | classifier | values | Input |
| F_{1,6} | F_{1,10} | 0.8 | 0.2 | 0 | 0 |
| F_{2,6} | F_{2,10} | 0.4 | 0.6 | 1 | 0 |
| | | | | | (mis- |
| | | | | | classified) |
| F_{3,6} | F_{3,10} | 0.9 | 0.1 | 0 | 0 |
| F_{4,6} | F_{4,10} | 0.6 | 0.4 | 0 | 0 |
| F_{5,6} | F_{5,10} | 0.7 | 0.3 | 0 | 0 |
| F_{6,6} | F_{6,10} | 0.9 | 0.1 | 0 | 0 |
| F_{7,6} | F_{7,10} | 1.0 | 0.0 | 0 | 0 |
| F_{8,6} | F_{8,10} | 0.6 | 0.4 | 0 | 0 |
| F_{9,6} | F_{9,10} | 0.6 | 0.4 | 0 | 0 |
| F_{10,6} | F_{10,10} | 0.7 | 0.3 | 0 | 0 |
| F_{11,6} | F_{11,10} | 0.1 | 0.9 | 1 | 1 |
| F_{12,6} | F_{12,10} | 0.2 | 0.8 | 1 | 1 |
| F_{13,6} | F_{13,10} | 0.1 | 0.9 | 1 | 1 |
| F_{14,6} | F_{14,10} | 0.2 | 0.8 | 1 | 1 |
| F_{15,6} | F_{15,10} | 0.4 | 0.6 | 1 | 1 |
| F_{16,6} | F_{16,10} | 0.3 | 0.7 | 1 | 1 |
| F_{17,6} | F_{17,10} | 0.1 | 0.9 | 1 | 1 |
| F_{18,6} | F_{18,10} | 0.2 | 0.8 | 1 | 1 |
| F_{19,6} | F_{19,10} | 0.3 | 0.7 | 1 | 1 |
| F_{20,6} | F_{20,10} | 0.2 | 0.8 | 1 | 1 |

Two performance indicators are calculated from table 11: (a) the Recall Rate for all samples: Number correct classified/total sample size=19/20=0.95; and (b) the Sharpness as the difference between the class memberships. In the instance that a sample is misclassified, the difference between the membership values is 0. (If more than 2 classes are defined the sharpness is calculated as the difference between the two highest membership values.)

Sharpness=(0.8−0.2)+0.0+(0.9−0.1)+ . . . +(0.7−0.3)+(0.9−0.1)+ . . . +(0.8−0.2)/20.0=0.52

Table 12 gives the result of the evaluation of the combination of features F_{z,6} and F_{z,10}.

TABLE 12

| | | |
|---|---|---|
| F_{z,6} | F_{z,10} | 95% correct in |
| | | predicting. |

Insofar as the objective is (a) to generate a list of the best m feature combinations rather than (b) to store all evaluated feature combinations, a sorted list (Stack 910) with a specified stack size is updated after the performance check of the combination regarding Table 10 as previously described.

The stack in Table 13 represents the situation after the evaluation of all combinations inclusive of the feature combination F_{z,8} and F_{z,9}. The features are sorted according to (a) the Recall Rate and then (b) for several combinations according to their Sharpness where the Recall Rate is identical.

TABLE 13
Sorted list with a stack size of 10

| | First | Second | | |
|---|---|---|---|---|
| | feature | feature | Recall | Sharp- |
| Pos. | value | value | Rate | ness |
| 1 | 6 | 10 | 0.95 | 0.52 |
| 2 | 6 | 7 | 0.95 | 0.48 |
| 3 | 4 | 9 | 0.90 | 0.45 |
| 4 | 7 | 10 | 0.90 | 0.42 |
| 5 | 6 | 9 | 0.85 | 0.43 |
| 6 | 5 | 7 | 0.85 | 0.40 |
| 7 | 7 | 8 | 0.80 | 0.39 |
| 8 | 4 | 8 | 0.80 | 0.39 |
| 9 | 2 | 10 | 0.80 | 0.37 |
| 10 | 5 | 9 | 0.75 | 0.35 |

After calculating the performance of the next combination F_{z,8} and F_{z,10} (Table 14) the stack is updated if the performance is superior to the performance of the last entry in the stack. In the example the current feature combination F_{z,8} and F_{z,10} is ranked at position 5 and the old position 10 falls out of the Stack. (Table 15).

TABLE 14
Current evaluation:

| First | Second | | |
|---|---|---|---|
| feature | feature | Recall | Sharp- |
| valued | value | Rate | ness |
| 8 | 10 | 0.90 | 0.42 |

TABLE 15
Updated list after evaluation feature combination 8|10.

| | First | Second | | |
|---|---|---|---|---|
| | feature | feature | Recall | Sharp- |
| Pos. | value | value | Rate | ness |
| 1 | 6 | 10 | 0.95 | 0.52 |
| 2 | 6 | 7 | 0.95 | 0.48 |
| 3 | 4 | 9 | 0.90 | 0.45 |
| 4 | 7 | 10 | 0.90 | 0.42 |
| 5 | 8 | 10 | 0.90 | 0.42 |
| 6 | 6 | 9 | 0.85 | 0.43 |
| 7 | 5 | 7 | 0.85 | 0.40 |
| 8 | 7 | 8 | 0.80 | 0.39 |
| 9 | 4 | 8 | 0.80 | 0.39 |
| 10 | 2 | 10 | 0.80 | 0.37 |

TABLE 16
Stack after testing all combination with two features.

| | First | Second | | |
|---|---|---|---|---|
| | feature | feature | Recall | Sharp- |
| Pos. | value | value | Rate | ness |
| 1 | 6 | 10 | 0.95 | 0.52 |
| 2 | 6 | 7 | 0.95 | 0.48 |
| 3 | 4 | 9 | 0.90 | 0.43 |
| 4 | 7 | 10 | 0.90 | 0.42 |
| 5 | 8 | 10 | 0.90 | 0.40 |
| 6 | 6 | 9 | 0.85 | 0.43 |
| 7 | 5 | 7 | 0.85 | 0.40 |
| 8 | 9 | 10 | 0.80 | 0.41 |
| 9 | 7 | 8 | 0.80 | 0.39 |
| 10 | 4 | 8 | 0.80 | 0.39 |

Proceeding now to Step 3, all combinations which are stored in table 16 (the best 10 pairs) are successively combined with all features not previously included in this pairing of features. Features for which low measures of quality have been calculated in the appraisal of the feature pairs can thus be re-included in the selection process. Tables 17-19 show phases in Step 3 consideration for three Features.

TABLE 17
All possible combination of the best pair F_{z,6},
F_{z,10} with all available features.

| | |
|---|---|
| 6 \| 10 \| 1 | F_{z,6}, F_{z,10}, and F_{z,1} |
| 6 \| 10 \| 2 | F_{z,6}, F_{z,10}, and F_{z,2} |
| 6 \| 10 \| 3 | F_{z,6}, F_{z,10}, and F_{z,3} |
| 6 \| 10 \| 4 | F_{z,6}, F_{z,10}, and F_{z,4} |
| 6 \| 10 \| 5 | F_{z,6}, F_{z,10}, and F_{z,5} |
| 6 \| 10 \| 7 | F_{z,6}, F_{z,10}, and F_{z,7} |
| 6 \| 10 \| 8 | F_{z,6}, F_{z,10}, and F_{z,8} |
| 6 \| 10 \| 9 | F_{z,6}, F_{z,10}, and F_{z,9} |

TABLE 18
Possible combinations of the stack pairs with
all available features.

| | | | | | |
|---|---|---|---|---|---|
| 1. | 6 | \| | 10 | \| | (1, 2, 3, 4, 5, 7, 8, 9) |
| 2. | 6 | \| | 7 | \| | (1, 2, 3, 4, 5, 8, 9) |
| 3. | 4 | \| | 9 | \| | (1, 2, 5, 6, 7, 8, 10) |
| 4. | 7 | \| | 10 | \| | (1, 2, 3, 5, 8, 9) |
| 5. | 8 | \| | 10 | \| | (1, 2, 3, 4, 5, 9) |
| 6. | 6 | \| | 9 | \| | (1, 2, 3, 4, 8, 10) |
| 7. | 5 | \| | 7 | \| | (1, 2, 3, 4, 8, 9, 10) |
| 8. | 9 | \| | 10 | \| | (1, 2, 3, 4, 5) |
| 9. | 7 | \| | 8 | \| | (1, 2, 3, 4, 9, 10) |
| 10. | 4 | \| | 8 | \| | (1, 2, 3, 9, 10) |

TABLE 19
Stack after testing all combination with three features.

| | First | Second | Third | | |
|---|---|---|---|---|---|
| | feature | feature | feature | Recall | Sharp- |
| Pos. | value | value | value | Rate | ness |
| 1 | 6 | 10 | 5 | 1.00 | 0.60 |
| 2 | 6 | 10 | 9 | 1.00 | 0.58 |
| 3 | 6 | 10 | 7 | 0.95 | 0.56 |
| 4 | 6 | 7 | 3 | 0.95 | 0.52 |
| 5 | 6 | 7 | 9 | 0.95 | 0.50 |
| 6 | 6 | 10 | 5 | 0.90 | 0.50 |
| 7 | 4 | 9 | 5 | 0.90 | 0.48 |
| 8 | 6 | 10 | 7 | 0.90 | 0.47 |
| 9 | 4 | 9 | 6 | 0.85 | 0.49 |
| 10 | 6 | 7 | 8 | 0.85 | 0.48 |

If the algorithm selects more then three features, the process is repeated (Step 3). A criteria is used to either end the process and accept a set of feature combinations or to enhance the feature set to four, five, six, etc. features until an acceptable level of membership prediction is achieved.

Variation of the stack size is a tuning parameter for the system. In this regard, and due to the linear effect of the stack size, the computing time can be shortened considerably by reducing the list length. For example, at a stack size=10, only the 10 best individual features are used in the second stage to form new feature combinations. However, as these are again combined with all N′ features, all features will continue to take part in the selection process, even if they do not belong to the best individual features. As quality in stack performance and the respective stack size tentatively depends considerably on the particular problem instance, a recommendation can, of course, only be given via the selection of the parameter list length (number of solutions to be pursued). However, as a general rule, according to the experience of the inventors, a sensible compromise between optimization of the computing time and the finding of a sub-optimum set of features is achieved with a stack size of preferably between 20 and 50 feature candidate combinations.

### End of Example 2

FIG. 20 presents detail in the neural network (NN) method of classifying and in evolutionary feature selection. Evolutionary Feature Selection Process 1900 shows a process of use for the evolutionary feature selection process; the classifier used is a neural network, but, in an alternative embodiment, the weighted distance classifier described in Progressive Feature Selection Process 1800 is used along with the evolutionary selection process. In Neural Network Initiation Step 1902, a particular neural network for use with a sample signal set given a primer configuration and the number of layers and neurons per layer are defined. In Neural Network Initial Fitness Step 1904, an initial feature set is defined to establish the scope of the network, and fitness of the neural network is evaluated against the initial feature set. In Neural Network Configuration Decision 1906, the fitness of Neural Network Initial Fitness Step 1904 is examined against a performance threshold to define acceptability of the neural network configuration. If the decision result is NO, Neural Network Configuration Decision 1906 terminates to Neural Network Reconfiguration Step 1908. If the decision result is YES, Neural Network Configuration Decision 1906 terminates to Primary Random Feature Set Generation Step 1910. In Neural Network Reconfiguration Step 1908, if the fitness of Neural Network Configuration Decision 1906 is insufficient, the neural network configuration is examined and modifications are proposed. If the result of Feature Set Size Decision 1926 is YES, the feature set size is decreased and the neural network configuration is examined and modifications are proposed. NN Reconfiguration Step 1908 then terminates to Neural Network Initiation Step 1902 for modification of the neural network configuration. In Primary Random Feature Set Generation Step 1910, following acceptability of the neural network configuration in Neural Network Configuration Decision 1906, feature subsets are generated using random feature selection. In Feature Set Ranking Step 1912, each feature subset is used (a) to train the neural network and derive a weighting matrix and then (b) to use the particular derived weighting matrix parameter instance in Neural Network Parameter Instance 912 to evaluate the sample vectors in predicting their memberships. The feature subsets are then ranked according to their prediction capability. In Feature Set Decision 1914, each new feature subset is evaluated for classification prediction fitness. If sufficient fitness prediction is not achieved by any feature set, then the process proceeds to Feature Subgroup Selection Step 1918. If sufficient fitness prediction is achieved by any feature set, then the process proceeds to Neural Network Feature Set Acceptance Step 1916; and the feature set defines the (sub-optimal) feature combination for use in NN Real-Time Parameters 914 for the particular signal. In Feature Subgroup Selection Step 1918, a best-performing subgroup of the ranked feature subsets of Feature Set Ranking Step 1912 are selected for further modification; each of these feature subsets in the subgroup is referred to as a “parent individual”. In Feature Subgroup Crossover Step 1920, “parent individuals” exchange certain features to define “new individuals”—this process is termed as “crossover”. In Feature Subgroup Mutation Step 1922, the “new individuals” of Feature Subgroup Crossover Step 1920 are further modified as to features by exchanging a specific number of features which were not included in the initial set of features evaluated in the feature subsets of 1912 with features in the “new individuals”—this process is termed as “mutation”. In Feature Set Reconfiguration Step 1924, the inferior-performing subgroup of the ranked feature subsets of Feature Set Ranking Step 1912 are replaced with the “new individuals” so that a new set of feature subsets (the “parent individuals” and the “new individuals”) is available. The generation counter is then incremented to designate a new generation of feature subsets for consideration. In Feature Set Size Decision 1926, change in the feature set size in view of the predictive capability of the prior generation is considered. This decision is determined by operating technician input via Human Interface Logic 412 interfacing or, in an alternative automated embodiment, from interaction with a rule set. If the decision result is NO, Feature Set Size Decision 1926 terminates to Feature Set Ranking Step 1912. If the decision result is YES, Feature Set Size Decision 1926 terminates to Neural Network Reconfiguration Step 1908.

An example of the evolutionary selection method according to the preferred embodiments is described in conjunction with reference to FIGS. 21A, 21B, 21C, and 21D which show evolutionary method steps and data sets 2800; FIGS. 21A-21D also provide diagrams showing affiliations between data variables and data values between dataset instances discussed in Example 3.

### EXAMPLE 3

In Step 1, setup of (1) a population size for feature combinations (where each combination is an “individual” in the population), (2) a feature set “gene pool” for the population, and (3) the number of feature “genes” per “individual” is defined. In this example, the feature “gene pool” has a Maximum Set Size of F_{z,1} . . . F_{z,10}. An opening Minimum Set of 2 features F_{z,x}-F_{z,y} for each individual is defined. A set of 5 individuals in the population is defined.

Respective to notation, “z” is the Object number for a particular individual having a feature set and membership in a class (i.e. when z is expressed as a numeric value, then F_{z,x} is considered to have a specific quantitative value in the example; when z is expressed as the textual “z”, then F_{z,x} is a logically identified variable representing a classifying feature in the example). An Object, therefore, is a feature vector and affiliated class membership value as a combination.

Proceeding to Step 2, the 5 individuals (note that the “individuals” of Table 20 are defined at the datalogical level of variables rather than at the level of specific measured Objects) with the selected minimum number of features (the 2 feature “gene combinations” of Step 1) are defined as a set of feature variables from the feature “gene pool” of F_{z,1} . . . F_{z,10} in a random manner to form Table 20 (further reference to Dataset 2802 of FIG. 21A).

TABLE 20

| | | |
|---|---|---|
| F_{Z,1} | F_{Z,8} | Combination 1-forming |
| | | Individual 1 |
| F_{Z,4} | F_{Z,10} | Combination 2-forming |
| | | Individual 2 |
| F_{Z,6} | F_{Z,2} | Combination 3-forming |
| | | Individual 3 |
| F_{Z,3} | F_{Z,1} | Combination 4-forming |
| | | Individual 4 |
| F_{Z,5} | F_{Z,9} | Combination 5-forming |
| | | Individual 5 |

In Step 3, the new feature combinations are used in relating to the Learning Data Set (Samples 2804, 2806) in Learning Database 1302 so that prior combined measurements of feature values and membership value combinations are acquired for training a classifier. In this first pass, (the Minimum Set of) 2 features F_{z,x}-F_{z,y} for each individual define a Feature Value Couplet in the Learning Data Set. In this example, essentially the simplest case, 2 measurements (Sample A 2804 and Sample B 2806) from the learning database are recovered showing past human evaluations of two measured situations (the evaluations being expressed quantitatively as Human Expert Membership Values) using Features 1-10 respective to a Membership Class A:

F_{1,1} . . . F_{1,10} having a Human Expert Membership Value 1

F_{2,1} . . . F_{2,10} having a Human Expert Membership Value 0

Human Expert Membership Value “1” or “0” indicates, respectively, whether or not the particular Feature Value combination measured instance (the Feature Value Couplet of this first pass) belongs to Class A. Two Objects in the database (note again that each F_{x,y} represents a quantitative value from a feature respective to a sample from the learning database) are read into the evolutionary selection method. Note again that only two feature values of the possible 10 in any one sample Object are used in this first evaluation.

Proceeding to Step 4, “weight adaptation” is performed to associate (a) data values from learning with (b) the combinations of features identified from random selection. Reviewing Steps 2 and 3, Table 20 was used to define all relevant feature values; then each relevant class membership is also affiliated with each Feature Value couplet respective to the learning database as shown (see Table 21 and Dataset 2808 of FIG. 21A for the Feature Value Couplets of this first pass with their associated Human Expert Membership Values). A consideration of the connections between Dataset 2802, Dataset 2808, and Learning Database 1302 in FIG. 21A shows datalogical nexus in this regard. In performing “weight adaptation” in this first pass, the neural network is trained respective to all of the Feature Value Couplets and their affiliated Membership Values shown in Table 21; or, alternatively, the Weighted Distance Classifier has a set of eigenvalues and eigenvectors defined respective to all the Feature Value Couplets and their affiliated Membership Values shown in Table 21 and Dataset 2808. The Neural Net, then, is trained according to the values of Table 21; or, alternatively, the Weighted Distance Classifier is trained according to the values of Table 21. The training step is shown in FIG. 21A as Derive Classifier Operation 2810. Derive Classifier Operation 2810 obtains values from Column 2812, Column 2814, and Column 2816 of Dataset 2808 (note that, even as the columns are conveniently identified, the system continues to relate to each Object, or effective row across all columns referenced, as a related data entity for use in classification).

TABLE 21

| First | Second | Membership Value |
|---|---|---|
| Feature | Feature | Measured from |
| Value | Value | Human Expert Input |
| F_{1,1} | F_{1,8} | 1 |
| F_{2,1} | F_{2,8} | 0 |
| F_{1,4} | F_{1,10} | 1 |
| F_{2,4} | F_{2,10} | 0 |
| F_{1,6} | F_{1,2} | 1 |
| F_{2,6} | F_{2,2} | 0 |
| F_{1,3} | F_{1,1} | 1 |
| F_{2,3} | F_{2,1} | 0 |
| F_{1,5} | F_{1,9} | 1 |
| F_{2,5} | F_{2,9} | 0 |

In Step 5, either (1) the trained Neural Network or, alternatively, (2) the trained Weighted Distance Classifier is used to generate Predicted Membership Values according to the quantitative Feature Value Couplets of Table 21. This is shown as Derive Predicted Membership Values Operation 2818 in FIG. 21A. In this regard, values from Column 2812 and Column 2814 of Dataset 2808 are read into Operation 2818 along with the Classifier Reference Instance (918, 912) derived in Operation 2810. Comparison of the Predicted Membership Value defined by the trained NN (trained WDC) to the Human Expert Membership Value originally measured is then performed. This is shown figuratively in Table 22 and in Dataset 2820 of FIG. 21B. Note that Dataset 2820 acquires its values from Column 2812, Column 2814, and Column 2816 of Dataset 2808 and also from Operation 2818 (note again that, even as the columns are conveniently identified, the system continues to relate to each Object, or effective row across all columns referenced, as a related data entity for use in classification).

TABLE 22

| | | Membership Value | |
|---|---|---|---|
| | | Predicted from using | |
| | | trained classifier | |
| | | (note these are examples of | Membership Value |
| First | Second | what the newly-trained | Measured from Human |
| Feature | Feature | classifier defines as a | Expert Input |
| Value | Value | Membership Value set) | (Table 21 value) |
| F_{1,1} | F_{1,8} | 1 | 1 |
| F_{2,1} | F_{2,8} | 1 | 0 |
| F_{1,4} | F_{1,10} | 0 | 1 |
| F_{2,4} | F_{2,10} | 1 | 0 |
| F_{1,6} | F_{1,2} | 1 | 1 |
| F_{2,6} | F_{2,2} | 0 | 0 |
| F_{1,3} | F_{1,1} | 1 | 1 |
| F_{2,3} | F_{2,1} | 0 | 0 |
| F_{1,5} | F_{1,9} | 0 | 1 |
| F_{2,5} | F_{2,9} | 1 | 0 |

From examination of Table 22 and Dataset 2820, conclusions (shown in Table 23) about the classification usefulness of individuals of Table 20 are drawn respective to the proposed plan of randomly-defined Table 20; these conclusions are based upon the performance (in this first pass) of the Feature Value Couplets and affiliated Membership Values recovered as Objects from the Learning Database according to the defined individuals of Table 20 when used by the classifier deployed.

TABLE 23

| | | |
|---|---|---|
| F_{Z,1} | F_{Z,8} | 50% correct in predicting since, as shown in Table 22, |
| | | one sample was properly classified and one sample was |
| | | not properly classified |
| F_{Z,4} | F_{Z,10} | 0% correct in predicting since, as shown in Table 22, |
| | | both samples were improperly classified |
| F_{Z,6} | F_{Z,2} | 100% correct in predicting since, as shown in Table 22, |
| | | each sample was properly classified |
| F_{Z,3} | F_{Z,1} | 100% correct in predicting since, as shown in Table 22, |
| | | each sample was properly classified |
| F_{Z,5} | F_{Z,9} | 0% correct in predicting since, as shown in Table 22, |
| | | both samples were improperly classified |

In Step 6, the five individuals of Table 20 are ranked according to their performance in predictive classification. Table 23 now is rearranged into Table 24. Dataset 2822 of FIG. 21B also shows the data arrangement of Table 24. In tracing the data-linkages shown between Dataset 2820 and Dataset 2822, the specific considerations of the conclusive (rightmost column) column of Table 24 and Dataset 2822 respective to the data in Table 22 (Dataset 2820) are demonstrated. Note that Table 23 is not shown as a dataset in the Figures.

TABLE 24

| | | |
|---|---|---|
| F_{Z,6} | F_{Z,2} | 100% correct in predicting since, as shown in Table 22, |
| | | each sample was properly classified |
| F_{Z,3} | F_{Z,1} | 100% correct in predicting since, as shown in Table 22, |
| | | each sample was properly classified |
| F_{Z,1} | F_{Z,8} | 50% correct in predicting since, as shown in Table 22, |
| | | one sample was properly classified and one sample was |
| | | not properly classified |
| F_{Z,5} | F_{Z,9} | 0% correct in predicting since, as shown in Table 22, |
| | | both samples were improperly classified |
| F_{Z,4} | F_{Z,10} | 0% correct in predicting since, as shown in Table 22, |
| | | both samples were improperly classified |

Proceeding now to Step 7, two of the combinations (individuals) of Table 20 are selected for generation of “children” in a set of two operations termed “crossover” and “mutation”; in this regard, and in the context of the definition of new “children”, the two chosen individuals of Table 20 are referenced as “parents”. The process is further shown in FIG. 21C. FIG. 21C reprises Dataset 2802. In example, the F_{z,6}-F_{z,2} combination is randomly chosen and the F_{z,5}-F_{z,9} combination is also randomly chosen (note, in spite of the fact that an “individual” may have been a “poor performer” in the prediction evaluation, the “individual” is still valid as a “parent” for creating a “child” for the system). Dataset 2826 shows the 2 parent features sets in FIG. 21C and the random choosing action is denoted as Operation 2824. In the crossover process itself (Step 8 and also indicated as Crossover 2828 in FIG. 21C) the F_{z,5}-F_{z,9} and the F_{z,6}-F_{z,2} features are exchanged. In crossing over, a feature “gene” from each of two randomly selected “parents” in Table 20 is used as one of each of the child feature “genes” (an examination of the datalinkages between Datasets 2830 and 2832 as they influence Datasets 2834 and 2836 further clarifies the crossover operation). The Table 20 “generation” has now become the Table 25 “generation” insofar as two “children” have been added to the original population of individuals of Table 20.

TABLE 25

| | | |
|---|---|---|
| F_{Z,1} | F_{Z,8} | Individual 1 |
| F_{Z,4} | F_{Z,10} | Individual 2 |
| F_{Z,5} | F_{Z,2} | Individual 3 - a child of Table 20 parents F_{z,5} - F_{z,9} and |
| | | F_{z,6} - F_{z,2} |
| F_{Z,3} | F_{Z,1} | Individual 4 |
| F_{z,5} | F_{z,9} | Individual 5 (a parent) |
| F_{z,6} | F_{z,2} | Individual 6 (a parent) |
| F_{Z,6} | F_{Z,9} | Individual 7 - a child of Table 20 parents F_{z,5} - F_{z,9 and} |
| | | F_{z,6} - F_{z,2} |

In Step 9, mutation of the new children of the Table 25 generation is performed (see Mutation Operations 2846 in FIG. 21C). In this regard, one of Features F_{z,1} to F_{z,10} which is not one of the feature “genes” of the new children in the generation of Table 24 is randomly selected for use in substitution (in each child) for a feature gene directly inherited from one of the parents in Operations 2838 and 2840. Operations 2842 and 2844 then execute to randomly discard one gene from each Child (Datasets 2834 and 2836, with the discarded feature “genes” shown as Blanks 2856 and 2858 of respective Datasets 2848 and 2850). The Features selected for substitution are then substituted the discarded feature “genes” (Blanks 2856 and 2858) in the children of Table 25. In example, Individual 7 is mutated to replace F_{z,6} with F_{z,7} and Individual 3 is mutated to replace F_{z,2} with F_{z,4} (see the movements from Dataset 2848 and 2850 into Datasets 2852 and 2854 with the inclusion of the features selected in Operations 2838 and 2840). The Table 25 “generation” has now mutated into the Table 26 (Dataset 2856) “generation”. The combination of Datasets 2802, 2852, and 2854 into Dataset 2856 is diagrammed in FIG. 21D.

TABLE 26

| | | |
|---|---|---|
| F_{Z,1} | F_{Z,8} | Individual 1 |
| F_{Z,4} | F_{Z,10} | Individual 2 |
| F_{Z,5} | F_{Z,4} | Individual 3 - a now mutated child of Table 20 parents F_{z,5} - |
| | | F_{z,9 and} F_{z,6} - F_{z,2} |
| F_{Z,3} | F_{Z,1} | Individual 4 |
| F_{z,5} | F_{z,9} | Individual 5 (a parent) |
| F_{z,6} | F_{z,2} | Individual 6 (a parent) |
| F_{Z,7} | F_{Z,9} | Individual 7 - a now mutated child of Table 20 parents F_{z,5} - |
| | | F_{z,9 and} F_{z,6} - F_{z,2} |

In Step 10, which can be termed “survival of the most fit”, the two worst-performing individuals of Table 20 (Fz_{z,4}-F_{z,10} & F_{z,5}-F_{z,9}) are replaced by the two new mutated children of Table 26 in Operation 2858; put another way, since only 5 combinations (individuals) are permitted in the performing population of a particular “generation”, a new Table for evaluation is defined from the three best performing “old folks” of Table 20 and the 2 new “mutated children” (who are too “young and untested” to be designated as either good or bad performers yet, but who are presumed to have predictive potential until tested otherwise) of Table 26. The process is further appreciated from the diagram of FIG. 21D which shows Dataset 2856 modified by Operation 2858 to remove individuals F_{z,4}-F_{z,10} & F_{z,5}-F_{z,9} according to the inputs of reprised Dataset 2822. The removal of individuals F_{z,4}-F_{z,10} & F_{z,5}-F_{z,9} is shown with respective Remove 2860 and Remove 2862 designators. The other individuals of Database 2822 are retained according to designator Retain 2864. The new Table for evaluation is shown as Table 27 and as Dataset 2866:

TABLE 27

| | | |
|---|---|---|
| F_{Z,1} | F_{Z,8} | Combination 1 |
| F_{Z,5} | F_{Z,4} | Combination 2 |
| F_{Z,6} | F_{Z,2} | Combination 3 |
| F_{Z,3} | F_{Z,1} | Combination 4 |
| F_{Z,7} | F_{Z,9} | Combination 5 |

Table 27 is then substituted for Table 20 and the process is repeated by returning to either Step 1 or Step 2. A criteria (not shown but which should be apparent in the context of the discussion) is used to (1) end the process of generation definition and evaluation and (2) accept a set of feature combinations; in the absence of achieving satisfaction of the criteria after a sufficient number of returns to Step 2, the feature “gene set” is enhanced (Step 1 is revisited from Step 8 to enhance the “gene set” per individual) to three (four, five, six, etc.) features, and the generation definition and evaluation process continues until an acceptable level of membership prediction (fulfillment of the criteria) is achieved.

### End of Example 3

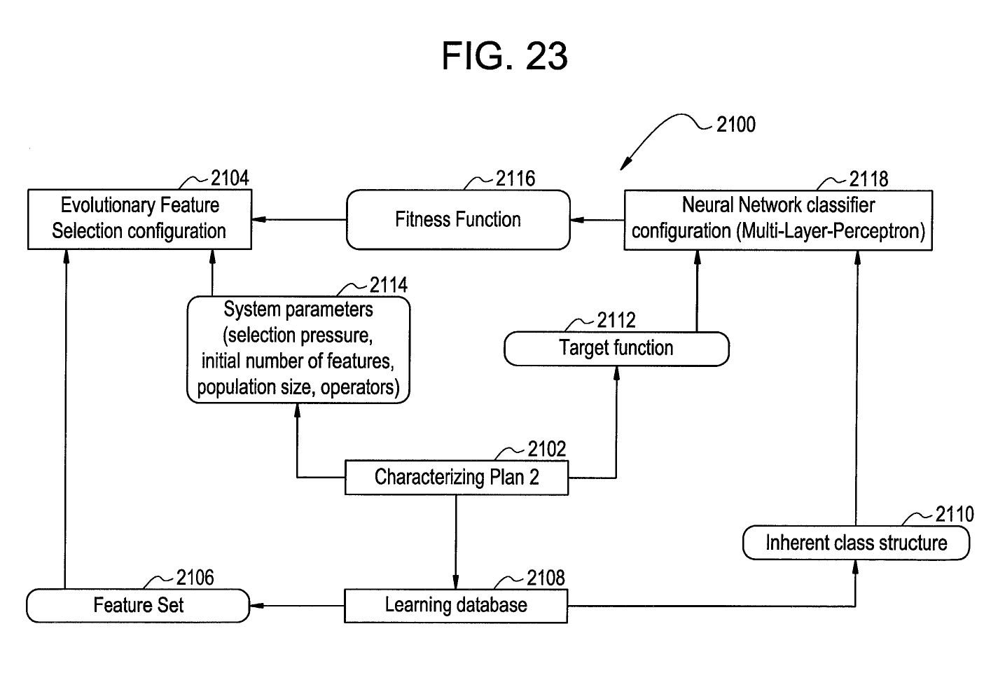

FIG. 22 presents an overview of interactive methods and data schema in the preferred embodiments for use of the weighted distance classification method and a progressive feature selection methodology. Progressive Selection with Weighted-Distance Characterization 2000 and Evolutionary Selection with Neural-Network Characterization 2100 (FIG. 23) overview informational and data design considerations for key broad data schema, functions, and parameter types in interaction with the methodologies used in the preferred embodiments. In this regard, a number of designations by the user are appropriate in crafting application of the embodiments to classification of a particular Mechanical Assembly 124. Progressive Selection with Weighted-Distance Characterization 2000 depicts an overview of the process which converges to a real-time feature subset by use of the Weighted Distance Classifier and Progressive Feature Selection method (Progressive Feature Selection Process 1800). Evolutionary Selection with Neural-Network Characterization 2100 depicts an overview of the process which converges to a real-time feature subset by use of the Neural Network and Evolutionary Selection method (Evolutionary Feature Selection Process 1900). As noted in Classification Overview 1700, alternative plans of use for the Progressive Feature Selection method (Progressive Feature Selection Process 1800) with the Neural Network or, alternatively, the Evolutionary Selection method (Evolutionary Feature Selection Process 1900) with the Weighted Distance Classifier are also contemplated; however, configuration decisions of these should be apparent in the context of the discussion of Progressive Selection with Weighted-Distance Characterization 2000 and Evolutionary Selection with Neural-Network Characterization 2100.

Plan 1 Approach 2002 requires Learning Database 2008 data and defined criteria for acceptable performance in Target Function 2012; an initial number of features, stack size, and fitness limit criteria are also defined by the user prior to configuration for System Parameters 2014. In this regard, the nature of the instance of Mechanical Assembly 124 to be monitored and controlled, the confidence needed to remove Mechanical Assembly 124 from operation for maintenance, and the capital at risk in Mechanical Assembly 124 should all be considered in setting performance criteria.

These same considerations are needed in Plan 2 Approach 2102 (FIG. 23) of Evolutionary Selection with Neural-Network Characterization 2100 (respective to Learning Database 2108, Target Function 2112, and System Parameters 2114—with the parameter types of System Parameters 2114 also including population size and operators respective to evolutionary selection operations).

Progressive Selection 2004 (FIG. 22) shows the endpoint of Plan 1 Approach 2002, the execution of feature definition from Feature Set 2006 and System Parameters 2014 using Fitness Function 2016 as generated from Weighted Distance Classifier 2018 in the context of Target Function 2012 and Class Structure 2010. Fitness Function 2016 is essentially defined by Weighted Distance Classifier 2018 once Target Function 2012 and Class Structure 2010 are provided.

FIG. 23 presents an overview of interactive methods and data schema in the preferred embodiments for use of the neural network classification method and an evolutionary feature selection methodology. Evolutionary Selection 2104 shows the endpoint of Plan 2 Approach 2102, the execution of feature definition from Feature Set 2106 and System Parameters 2114 using Fitness Function 2116 as generated from Neural Network Classifier 2118 in the context of Target Function 2112 and Class Structure 2110. Fitness Function 2116 is essentially defined by Neural Network Classifier 2118 once Target Function 2112 and Class Structure 2110 are provided.

FIG. 24 presents a unified mechanical assembly of machine components and attached sensors. Component Assembly 2200 shows an exemplary instance of Mechanical Assembly 124 to show detail in interactions between components of Mechanical Assembly 124, sensors, and Signal Filtering Board 114. Motor 2202 has components Left Motor Bearing 2208 and Right Motor Bearing 2210. Gearbox 2204 has components Left Gearbox Bearing 2212 and Right Gearbox Bearing 2214. Centrifuge 2206 has components Left Centrifuge Bearing 2216 and Right Centrifuge Bearing 2218. Left Motor Bearing 2208 is monitored by Sensor 2220 with the combination being designated in Component Database 1308 as a first instance of Component Identifier 1338 and Sensor Type 1340; Right Motor Bearing 2210 is monitored by Sensor 2222 with the combination being designated in Component Database 1308 as a second instance of Component Identifier 1338 and Sensor Type 1340; Left Gearbox Bearing 2212 is monitored by Sensor 2224 with the combination being designated in Component Database 1308 as a third instance of Component Identifier 1338 and Sensor Type 1340; Right Gearbox Bearing 2214 is monitored by Sensor 2226 with the combination being designated in Component Database 1308 as a fourth instance of Component Identifier 1338 and Sensor Type 1340; Left Centrifuge Bearing 2216 is monitored by Sensor 2228 with the combination being designated in Component Database 1308 as a fifth instance of Component Identifier 1338 and Sensor Type 1340; and Right Centrifuge Bearing 2218 is monitored by Sensor 2230 with the combination being designated in Component Database 1308 as a sixth instance of Component Identifier 1338 and Sensor Type 1340. Sensor 2220 generates a time-variant electrical voltage signal to Signal Wire Terminators 212a. Sensor 2222 generates a time-variant electrical voltage signal to Signal Wire Terminator 212b. Sensor 2224 generates a time-variant electrical voltage signal to Signal Wire Terminator 212c. Sensor 2226 generates a time-variant electrical voltage signal to Signal Wire Terminator 212d. Sensor 2228 generates a time-variant electrical voltage signal to Signal Wire Terminator 212e (per Band-Pass-Filter Circuitry Board 204, a second instance of Signal Filtering Board 114 in Classification Computer System 110 is provided for this channel and the channel respective to Sensor 2230). Sensor 2230 generates a time-variant electrical voltage signal to Signal Wire Terminator 212f. Connector 2232 connects Right Motor Bearing 2210 and Left Gearbox Bearing 2212 to provide either a rigorous or essentially rigorous coupling. Connector 2234 connects Right Gearbox Bearing 2214 and Left Centrifuge Bearing 2216 to provide either a rigorous or essentially rigorous coupling.

With regard to sensors used in gas turbine monitoring, U.S. Pat. No. 5,612,497 for an “Adaptor For Mounting A Pressure Sensor To A Gas Turbine Housing”, which issued on Mar. 18, 1997 to Hilger Walter, Herwart Hönen, and Heinz Gallus, is useful in acquiring a signal from compressor air pressure fluctuations; this patent is hereby incorporated by reference.

FIG. 25 presents a block flow summary showing toolbox development information flow for a particular set of unified mechanical assemblies and machine components. Toolbox Development Overview 2300 depicts sources from which data values for Machine Analysis Toolbox 1402 are acquired. Plant Experience 2302 shows experience gained over time from operation of a particular instance of Mechanical Assembly 124. Test Bench Information 2304 represents data gained from test bench work from operation of particular components in simulated test situations. Historical Data 2306 represents (1) the historical assembly of experience from operation of various instances of Mechanical Assembly 124 and (2) data values from respective Candidate Feature Database 1304 and Learning Database 1302 instances. Data acquired from the literature augments Plant Experience 2302 and Test Bench Information 2304. Plant Experience 2302, Test Bench Information 2304, and Historical Data 2306 are combined into data for Candidate Feature Database 1304 and Learning Database 1302 information when configuring an instance of either Weighted Distance Real-Time Parameters 916 or NN Real-Time Parameters 914.

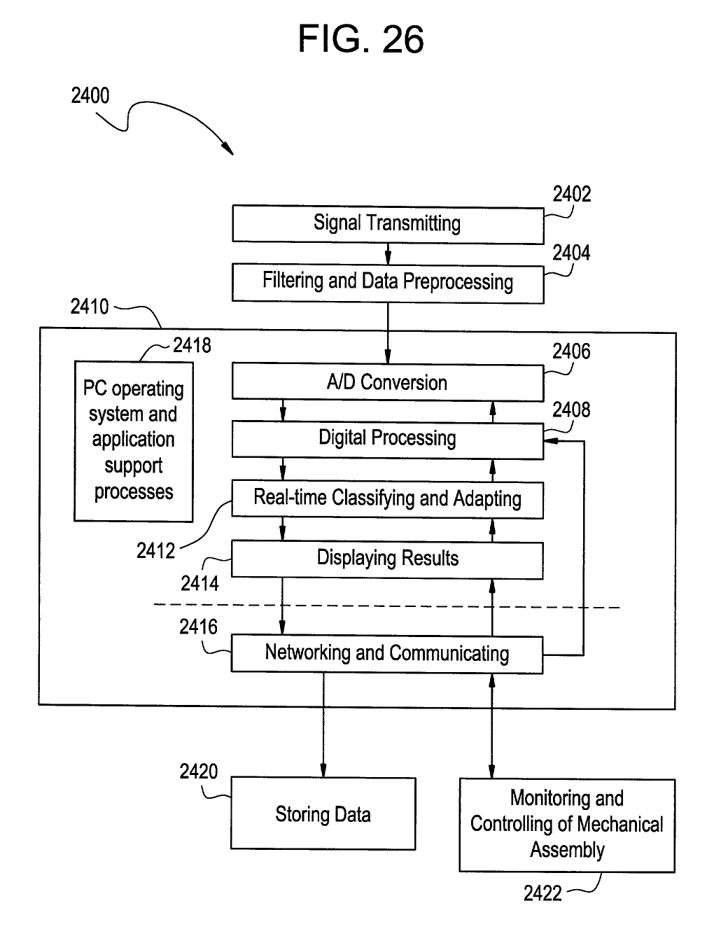

FIG. 26 presents a view of key logical components, connections, and information flows in use of the monitoring system in a monitoring use of the preferred embodiment. Concurrent Monitoring Processes 2400 shows key processes which are essentially simultaneously active and interactive in providing functionality in monitoring and (optionally) adaptive controlling in use of the embodiments. Signal Transmitting Operation 2402 represents the process of sensing motional attributes of components in Mechanical Assembly 124 and conveying an electrical signal in real-time to a Signal Wire Terminator 212 instance. Data Preprocessing Operation 2404 shows actions responsive to the electrical signal in Signal Filtering Board 114 to generate a Signal Filtering Board 114 output signal. A/D Operation 2406 shows actions responsive to the Signal Filtering Board 114 output signal in Data Acquisition Board 112. Digital Data Processing Operation 2408 shows further linearization actions in Real-Time Signal Input Engine 1108 on the Data Acquisition Board 112 output digital value to provide a signal for Feature Derivation Engine 1102 processing. Collected Classifying Logical Operations 2410 summarizes logical operations executed by Classification Computer Logic 140. Classifying Operation 2412 summarizes operations using Signal I/O Logic 408, Pattern Recognition Logic 406, Reference Data Logic 404, and Human Interface Logic 412. Displaying Operation 2414 summarizes operations using Human Interface Logic 412 to output information to an operating technician. Networking Operation 2416 summarizes operations using PI Buffer 1114 and Network Interface 1116. Real-time coordination Operation 2418 shows needed support processes such as a Windows or DOS Operating System (Windows and DOS are trademarks of Microsoft Corporation) and operations of Real-Time Executive Logic 402. Storage Operation 2420 shows the storage of data either within Classification Computer Logic 140 or in an external system such as Process Information System 104 or a system accessed via Network 146. Process Controlling Operation 2422 shows actions in Process Information System 104, Communications Interface 106, and Control Computer 108.

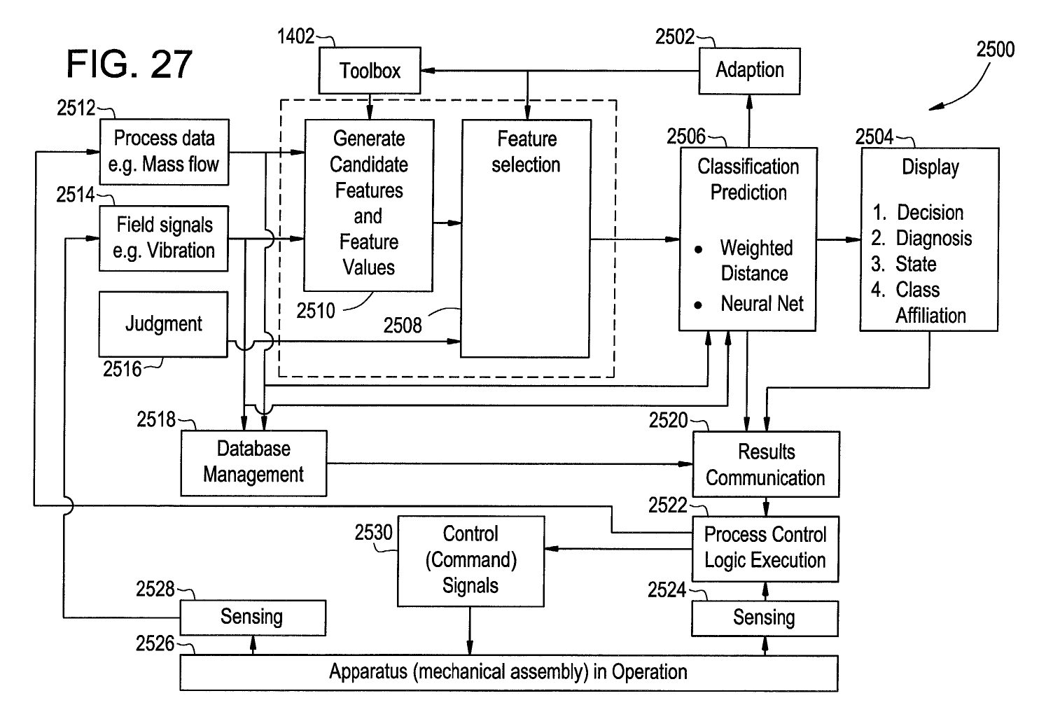

FIG. 27 presents a view of key logical components, connections, and information flows in use of the monitoring system in an adaptive control use of the preferred embodiment. Adaptive Controlling Processes 2500 further expands on the depiction of processes of Concurrent Monitoring Processes 2400 to show further details in some processes, key infological processes, and data sources. Classifying Operation 2412 has further detail shown in the actions of Classifier Adaptation Operation 2502, Machine Analysis Toolbox 1402, Classification Operation 2506, Feature Selection Operation 2508, Candidate Feature Generation Operation 2510, Judgment Input Operation 2516 (provided by a configuration expert), and Database Management Operation 2518 (also provided by a configuration expert). Details of Band-Pass-Filter Circuitry Board 204 are further shown in the processes of Apparatus Functional Operation 2526, Process Control Sensing Operation 2524, Direct Sensing Operation 2528, Real-time Control Operation 2522, Judgment Input Operation 2516, Process Signal Reading Operation 2514, and Process Data Reading Operation 2512. Displaying Operation 2414 details are further depicted as processes shown in Display Operation 2504 and Results Communication Operation 2520. Results Communication Operation 2520, Real-time Control Operation 2522, and Command Signal Operation 2530 also show the processes which “close the loop” to enable adaptive control of Mechanical Assembly 124 according to the results of Classification Computer Logic 140 analysis. In the context of Adaptive Controlling Processes 2500 and its depiction of co-existent operations, Apparatus Functional Operation 2526 shows operational Mechanical Assembly 124.

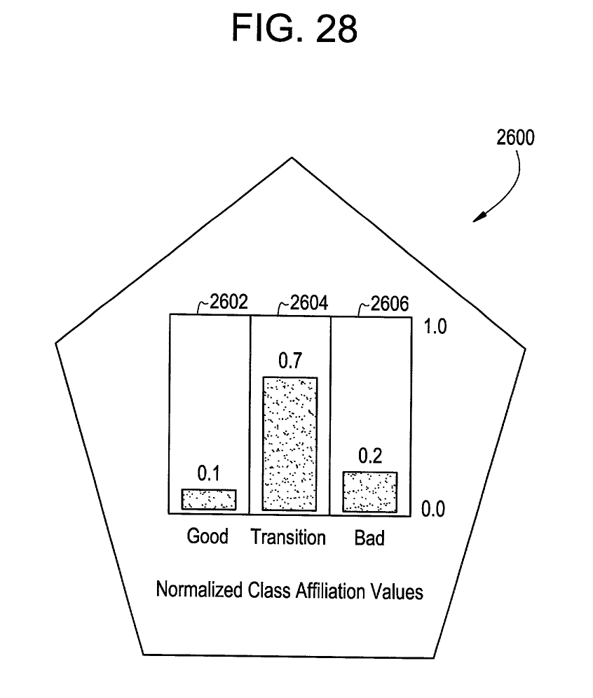

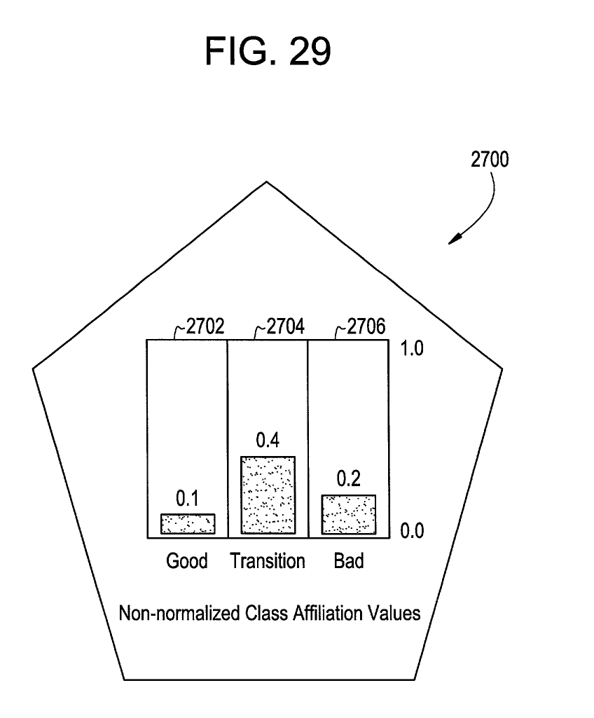

FIG. 28 shows an example of a graphical icon depiction of class affiliation parameter values in normalized form, and FIG. 29 shows an example of a graphical icon depiction of class affiliation parameter values in non-normalized form. Normalized Membership Depiction 2600 shows output on Monitor 102 for communication of classification of Mechanical Assembly 124 to an operating technician. “Good” Normalized Membership Value 2602 shows the membership of Mechanical Assembly 124 in operation in a “Good” Class. “Transitional” Normalized Membership Value 2604 shows the membership of Mechanical Assembly 124 in a “Transitional” Class. “Bad” Normalized Membership Value 2606 shows the membership of Mechanical Assembly 124 in a “Bad” or “Unacceptable” Class. The overall status of Mechanical Assembly 124 according to Normalized Membership Depiction 2600 communicates a need for awareness and vigilance on the part of the operating technician. Normalized Membership Depiction 2600 shows normalized values—i.e., the total of “Good” Normalized Membership Value 2602, “Transitional” Normalized Membership Value 2604, and “Bad” Normalized Membership Value 2606 are forced to equal 100% (as a second normalization after lo normalization of input data according to Sample Signal Preparation Step 1702). Basic Membership Depiction 2700 of FIG. 29 shows an example of non-normalized or basic data. “Good” Basic Membership Value 2702 shows the membership of Mechanical Assembly 124 in a “Good” Class, “Transitional” Basic Membership Value 2704 shows the membership of Mechanical Assembly 124 in a “Transitional” Class, and “Bad” Basic Membership Value 2706 shows the membership of Mechanical Assembly 124 in a “Bad” Class; but, in Basic Membership Depiction 2700, the sum of “Good” Basic Membership Value 2702, “Transitional” Basic Membership Value 2704, and “Bad” Basic Membership Value 2706 is not 100%. Both Normalized Membership Depiction 2600 and Basic Membership Depiction 2700 output characterizations to an operating technician are valid in use of the preferred embodiments, depending on the preferences of the operating technician and configuring expert.

The approach of the Strackeljan dissertation, the toolbox, 30 and the adaptive capability of the described embodiments provide a new system for machine diagnosis which enables an integrated solution to machine monitoring and adaptive control while also providing for rapid deployment of a diagnostic system respective to the installation date of a new machine.

The described embodiments are achieved within a number of computer system architectural alternatives. In one embodiment, an IBM Personal Computer 300PL using a 400 MHz CPU with a 6 GB Hard Drive from IBM Corporation and a Windows 98 operating system by Microsoft Corporation provides a platform for Classification Computer System 110. Other operating systems such as Microsoft's earlier DOS operating system can also be used. In one alternative, an embodiment is facilitated within the context of a multi-process environment wherein the different databases, data sections, and logical engines are simultaneously installed and activated with data transfer linkages facilitated either directly or indirectly via the use of a data common and/or an application program interface (APIs). In another alternative, the different databases, data sections, and logical engines are facilitated within the context of a single process environment wherein different components are sequentially activated by an operating technician with linkages facilitated either directly or indirectly via the use of data commons or data schema dedicated to interim storage. In yet another alternative, the different databases, data sections, and logical engines are deployed within the context of a single process environment wherein (a) some components of the different databases, data sections, and logical engines are accessed and activated by an operating technician with linkages facilitated either directly or indirectly via the use of data commons or data schema dedicated to interim storage, and (b) the other components within the different databases, data sections, and logical engines are accessed by calls with previously-installed routines. In one alternative, the classifier, different databases, data sections, and logical engines are implemented and executed on one physical computer. In another alternative, the different databases, data sections, and logical engines are facilitated on different platforms where the results generated by one engine are transferred by an operating technician to a second or other plurality of the different databases, data sections, and logical engines executing on different computer platforms, although a separate operating system is needed on each platform. In yet another alternative, the classifier, different databases, data sections, and logical engines are facilitated on a plurality of computer platforms interconnected by a computer network, although a separate operating system is needed on each platform and the operating system further incorporates any networking logic that is needed to facilitate necessary communications via such a computer implemented communication network. Many of the different gradations of architectural deployment within the context of the above overview are considered by the applicants to be generally apparent, and the illustration of the present invention can be conveniently modified by those of skill, given the benefit of this disclosure, to achieve the utility of the present invention within the context of the above computer system architectural alternatives without departing from the spirit of the present invention once given the benefit of the disclosure.

We claim:

1. A computer-implemented monitoring system, comprising:
a toolbox of machine analysis data feature tools, each data feature tool having a predetermined set of candidate data features for a type of sensor and related machine component in a unified mechanical component assembly;
means for designating one said data feature tool for classifying use respective to at least one defined class;
means for measuring an input signal from said sensor;
means for collecting a plurality of said measured input signals as a measured input signal set;
means for obtaining a human-determined class affiliation parameter value for each measured input signal in said measured input signal set;
means for calculating a feature value set respective to each measured input signal and respective to at least one data feature from said set of candidate data features;
means for deriving a classifier reference parameters instance from the feature value set and associated human-determined class affiliation parameter values respective to said measured input signal set and from a plurality of said candidate data features;
a classifier for defining a computer-determined class affiliation parameter value for a measured input signal respective to each class defined, said classifier in data communication with said classifier reference parameters instance to define each computer-determined class affiliation parameter value;
means for selecting a subset of data features from said candidate data features, said means for selecting in data communication with said measured input signal set, said associated human-determined class affiliation parameter values, said means for deriving a classifier reference parameter instance, and said classifier;
means for retaining the classifier reference parameters instance respective to said selected subset of features as a real-time reference parameter set;
means for graphically displaying at least one computer-determined class affiliation parameter value respective to an input signal measured in real-time from said assembly and respective to said real-time reference parameter set; and
a real-time executive means for directing the operation of said means for measuring input signals, said means for calculating a feature value set, said classifier, and said means for graphically displaying so that a graphical display of at least one computer-determined class affiliation parameter value is implemented in real-time respective to an input signal measured in real-time from said assembly.

2. A computer-implemented monitoring system, comprising:
a toolbox of machine analysis data feature tools, each data feature tool having a predetermined set of candidate data features for a type of sensor and related machine component in a unified mechanical component assembly;
means for designating one said data feature tool for classifying use respective to at least one defined class and a particular sensor;
means for measuring an input signal from said sensor;
means for determining at least-one computer-determined class affiliation parameter value for any said input signal respective to said candidate data features;
means for graphically displaying said class affiliation parameter value respective to said input signal when measured in real-time from said assembly; and
a real-time executive means for directing the operation of said means for measuring, said means for determining, and said means for graphically displaying so that a graphical display of at least one computer-determined class affiliation parameter value is implemented in real-time respective to an input signal measured in real-time from said assembly.

3. The monitoring system of claim 1 wherein said classifier is a weighted-distance classifier, said means for selecting implements progressive extraction of data feature subsets and tests each subset through use of said weighted-distance classifier to define a performance measure for that subset, and said monitoring system further comprises a stack database for holding a predetermined plurality of data feature subsets demonstrating the most favorable performance measures among all data feature subsets tested.

4. The monitoring system of claim 1, further comprising:
neural network training logic in said means for deriving for deriving a neural network parameters instance as said classifier reference parameters instance;
a neural network classifier as said classifier, said neural network classifier in data communication with said neural network parameters instance; and
a stack database;
wherein said means for selecting implements progressive extraction of data feature subsets and tests each subset through use of said neural network classifier to define a performance measure for that subset, and said stack database holds a predetermined plurality of the data feature subsets demonstrating the most favorable performance measures among all data feature subsets tested.

5. The monitoring system of claim 1, further comprising:
neural network training logic in said means for deriving for deriving a neural network parameters instance as said classifier reference parameter instance;
a neural network classifier as said classifier, said neural network classifier in data communication with said neural network parameters instance; and
a stack database;
wherein said means for selecting randomly identifies data features for a plurality of data feature subsets and tests each subset through use of said neural network classifier to define a performance measure for that subset, and said stack database holds a predetermined plurality of the data feature subsets demonstrating the most favorable performance measures among all data feature subsets tested.

6. The monitoring system of claim 1, wherein:
said means for deriving derives a weighted-distance classifier reference parameters instance;
said means for deriving further comprises neural network training logic for deriving a neural network parameters instance;
said classifier comprises a weighted-distance classifier in data communication with said weighted-distance classifier reference parameters instance, and said classifier further comprises a neural network classifier in data communication with said neural network parameters instance;
said means for selecting implements progressive extraction of data feature subsets wherein each subset is tested through use of said weighted-distance classifier to define a performance measure for that subset;
said means for selecting randomly identifies data features for a plurality of data feature subsets and tests each subset through use of said neural network classifier to define a performance measure for that subset;
said monitoring system further comprises a stack database for holding a predetermined plurality of the data feature subsets demonstrating the most favorable performance measures among all data feature subsets tested;
said monitoring system further comprises means for retaining the neural network parameters instance respective to said selected subset of features as a real-time neural network reference parameter set;
said monitoring system further comprises means for retaining the weighted-distance classifier reference parameters instance respective to said selected subset of features as a real-time weighted-distance reference parameter set;
said monitoring system further comprises means for specifying use of either of said weighted-distance classifier and said neural network classifier; and
said means for graphically displaying displays at least one computer-determined class affiliation parameter respective to either of the real-time neural reference network parameter set and real-time weighted-distance reference parameter set, respective to the specified classifier.

7. The monitoring system of claim 1, further comprising:
means for determining class affiliation parameter values of any said input signal respective to said candidate data features through use, in the alternative, of either of a weighted-distance classifier and a neural network classifier, said weighted-distance classifier selected for use when said predetermined set of candidate data features contains a plurality of data features numbering less than a predetermined threshold value, and said neural network classifier selected for use when said predetermined set of candidate data features contains a plurality of data features numbering not less than said predetermined threshold value.

8. A computer-implemented monitoring system for monitoring a sensor and related machine component in a mechanical component assembly, comprising:
a predetermined set of candidate data features for classifying said sensor respective to at least two defined classes;
means for real-time measurement of an input signal from said sensor;
means for determining a first computer-determined class affiliation parameter value for said input signal from said candidate data feature set in reference to a first classifying parameter set respective to a first class, and a second computer-determined class affiliation parameter value for said input signal from said candidate data feature set in reference to a second classifying parameter set respective to a second class;
means for deriving, during real-time measurement and class affiliation parameter value determination, a third classifying parameter set for said input signal respective to said first class and a fourth classifying parameter set for said input signal respective to said second class when all computer-determined class affiliation parameter values respective to an input signal measurement in real-time have a quantity less than a predetermined threshold value, said third and fourth classifying parameter sets incorporating the influence of said input signal measurement; and
means for replacing said first and second classifying parameter sets respectively with said third and fourth classifying parameter sets so that said third and fourth classifying parameter sets respectively become new said first and second classifying parameter sets when said third and fourth classifying parameter sets have been derived.

9. The system of any of claims 1, 2, and 8, further comprising:
output means for transmitting command signals which include at least one manipulated parameter variable that is used to govern said assembly; and
means for deriving said manipulated parameter variable from said computer-determined class affiliation parameter value;
wherein said real-time executive means directs the operation of said means for deriving said manipulated parameter variable so that said monitoring system is a process control system implementing control of said assembly in real-time.

10. The system of any of claims 1, 2, and 8 wherein said means for measuring further comprises a multiple-stage band-pass galvanic-isolation filter circuit.

11. A computer-implemented system for classifying a type of sensor and related machine component in a unified mechanical component assembly, comprising:
means for deriving a dimensionless peak amplitude data feature;
means for measuring an input signal from said sensor;
means for obtaining a class affiliation parameter value for said measured input signal respective to said dimensionless peak amplitude feature.

12. A computer-implemented system for classifying a type of sensor and related machine component in a unified mechanical component assembly, comprising:
means for deriving a dimensionless peak separation feature;
means for measuring an input signal from said sensor;
means for obtaining a class affiliation parameter value for said measured input signal respective to said dimensionless peak separation feature.

13. A computer-implemented method, comprising the steps of:
providing a toolbox of machine analysis data feature tools, each data feature tool having a predetermined set of candidate data features for a type of sensor and related machine component in a unified mechanical component assembly;
designating one said data feature tool for classifying use respective to at least one defined class;
measuring an input signal from said sensor;
collecting a plurality of said measured input signals as a measured input signal set;
obtaining a human-determined class affiliation parameter value for each measured input signal in said measured input signal set;
calculating a feature value set respective to each measured input signal and respective to at least one data feature from said set of candidate data features;
deriving a classifier reference parameters instance from the feature value set and associated human-determined class affiliation parameter values respective to said measured input signal set and from a plurality of said candidate data features;
using a classifier in defining a computer-determined class affiliation parameter value from said classifier reference parameters instance for a measured input signal respective to each class defined;
selecting a subset of data features from said candidate data features, said measured input signal set, said associated human-determined class affiliation parameter values, a plurality of said derived classifier reference parameter instances, and said classifier by evaluating a plurality of data feature combinations until acceptable classification is achieved;
retaining the classifier reference parameters instance respective to said selected subset of features as a real-time reference parameter set;
classifying in real-time said measured input signal from said real-time reference parameter set to establish a real-time computer-determined class affiliation parameter value; and
graphically displaying in real-time said real-time computer-determined class affiliation parameter value so that a graphical display of at least one computer-determined class affiliation parameter value is implemented in real-time respective to an input signal measured in real-time from said assembly.

14. A computer-implemented method, comprising the steps of:
providing a toolbox of machine analysis data feature tools, each data feature tool having a predetermined set of candidate data features for a type of sensor and related machine component in a unified mechanical component assembly;
designating one said data feature tool for classifying use respective to at least one defined class and a particular sensor;
measuring an input signal from said sensor;
determining at least-one computer-determined class affiliation parameter value for any said input signal respective to said candidate data features;
graphically displaying said class affiliation parameter value respective to said input signal when measured in real-time from said assembly; and
directing the operation of said steps of measuring, determining, and graphically displaying so that a graphical display of at least one computer-determined class affiliation parameter value is implemented in real-time respective to an input signal measured in real-time from said assembly.

15. The method of claim 13 wherein said classifier is a weighted-distance classifier, said selecting step progressively extracts data feature subsets and tests each subset using said weighted-distance classifier to define a performance measure for that subset, and said method further comprises the step of:
holding, in a stack database, a predetermined plurality of data feature subsets demonstrating the most favorable performance measures among all data feature subsets tested.

16. The method of claim 13 wherein a neural network is said classifier, a neural network parameters instance is derived in said deriving step as said classifier reference parameter instance, and, in said selecting step, progressively extracted data feature subsets are each tested using said neural network to define a performance measure for that subset, and said method further comprises the step of:
holding, in a stack database, a predetermined plurality of data feature subsets demonstrating the most favorable performance measures among all data feature subsets tested.

17. The method of claim 13 wherein a neural network is said classifier, a neural network parameters instance is derived in said deriving step as said classifier reference parameter instance, and, in said selecting step, randomly identified data feature subsets are each tested using said neural network to define a performance measure for that subset, and said method further comprises the step of:
holding, in a stack database, a predetermined plurality of data feature subsets demonstrating the most favorable performance measures among all data feature subsets tested.

18. The monitoring method of claim 13, wherein said classifier comprises both a weighted-distance classifier and a neural network classifier, said selecting step progressively extracts data feature subsets and tests each subset through use of said weighted-distance classifier when specified in defining a performance measure for that subset, said selecting step randomly identifies data features for a plurality of data feature subsets and tests each subset using said neural network classifier when specified in defining a performance measure for that subset, and said method further comprises the steps of:
specifying use of either of said weighted-distance classifier and said neural network classifier; and
holding, in a stack database, a predetermined plurality of the data feature subsets demonstrating the most favorable performance measures among all data feature subsets tested; wherein
said deriving step derives a weighted-distance classifier reference parameters instance using said weighted-distance classifier when specified;
said deriving step derives a neural network parameters instance using said neural network classifier when specified;
said retaining step retains the neural network parameters instance respective to said selected subset of features as a real-time neural network reference parameter set when said neural network classifier is specified; and
said retaining step retains the weighted-distance classifier reference parameters instance respective to said selected subset of features as a real-time weighted-distance reference parameter set when said weighted-distance classifier is specified.

19. The method of claim 13, further comprising the step specifying for use, in the alternative, of either of a weighted-distance classifier and a neural network classifier, said weighted-distance classifier specified for use when said predetermined set of candidate data features contains a plurality of data features numbering less than a predetermined threshold value and said neural network classifier specified for use when said predetermined set of candidate data features contains a plurality of data features numbering not less than said predetermined threshold value.

20. A computer-implemented method for monitoring a sensor and related machine component in a mechanical component assembly, comprising the steps of:
providing a predetermined set of candidate data features for classifying said sensor respective to at least two defined classes;
measuring in real-time an input signal from said sensor;
determining a first computer-determined class affiliation parameter value for said input signal from said candidate data feature set in reference to a first classifying parameter set respective to a first class;
determining a second computer-determined class affiliation parameter value for said input signal from said candidate data feature set in reference to a second classifying parameter set respective to a second class;
deriving, during said real-time measuring and determining steps, a third classifying parameter set for said input signal respective to said first class and a fourth classifying parameter set for said input signal respective to said second class when all computer-determined class affiliation parameter values respective to an input signal measurement in real-time have a quantity less than a predetermined threshold value, said third and fourth classifying parameter sets incorporating the influence of said input signal measurement; and
replacing said first and second classifying parameter sets respectively with said third and fourth classifying parameter sets so that said third and fourth classifying parameter sets respectively become new said first and second classifying parameter sets when said third and fourth classifying parameter sets have been derived.

21. The monitoring system of any of claims 13, 14, and 20, further comprising the steps of:
deriving a manipulated parameter variable from said computer-determined class affiliation parameter value; and
governing said assembly with said manipulated parameter variable;
so that said assembly is controlled in real-time.

22. A computer-implemented method for classifying a type of sensor and related machine component in a unified mechanical component assembly, comprising:
deriving a dimensionless peak amplitude data feature;
measuring an input signal from said sensor;
obtaining a class affiliation parameter value for said measured input signal respective to said dimensionless peak amplitude feature.

23. A computer-implemented method for classifying a type of sensor and related machine component in a unified mechanical component assembly, comprising:
deriving a dimensionless peak separation feature;
measuring an input signal from said sensor;
obtaining a class affiliation parameter value for said measured input signal respective to said dimensionless peak separation feature.

24. A computer-implemented method for classifying a type of sensor and related machine component in a unified mechanical component assembly, comprising the steps of:
defining a feature set for classification from a set of candidate features and a learning database using evolutionary selection, said learning database having a set of evaluated instances, said evolutionary selection having the sequential operations of:
defining a population size for a population of feature combination instances;
defining a set of evaluation features for said population from said set of candidate features;
defining an evaluation feature set size;
randomly selecting, from said candidate features, a population instance of feature set instances of said evaluation feature set size, said population instance having said population size;
training a classifier according to said population instance and said learning database;
evaluating the prediction capability of each feature set instance using said trained classifier;
designating said feature set instance as a real-time classification feature set if said evaluating fulfills a criteria;
selecting, if said criteria is unfulfilled, a subset group of said feature set instances according to said evaluated prediction capabilities;
generating a child subset group of said feature set instances by randomly selecting one of said features from each of two randomly chosen feature set instances and combining each of said selected features into a new feature set instance;
mutating said new feature set instance by randomly selecting one of said features in said new feature set instance and replacing said selected feature with a randomly selected feature from said set of evaluation features for said population with the proviso that said replacement feature is other than either of said features in said new feature set instance prior to initiation of said mutating operation;
defining a new population instance from said subset group and at least one said mutated feature set instance with the proviso that said mutating operating is executed until said new population instance achieves said population size; and
returning to said training operation;
acquiring a set of features in real-time from said sensor; and
classifying said acquired set of features by using said real-time classification feature set.
